(19) United States
(12) Patent Application Publication
(10) Pub. No.: US 2024/0033738 A1
(43) Pub. Date: Feb. 1, 2024

(54) FLOW CELL BASED MOTION SYSTEM CALIBRATION AND CONTROL METHODS

(71) Applicant: ILLUMINA, INC., San Diego, CA (US)

(72) Inventors: Michael Burek, San Diego, CA (US); Gregory Holst, San Diego, CA (US); Danilo Condello, New York, NY (US); Dustin Blair, Escondido, CA (US)

(21) Appl. No.: 18/357,006

(22) Filed: Jul. 21, 2023

Related U.S. Application Data
(60) Provisional application No. 63/369,563, filed on Jul. 27, 2022.

(51) Int. Cl. B01L 3/00

(52) U.S. Cl. CPC B01L 3/502761; B01L 2200/0652; B01L 2300/0654; B01L 2200/16; B01L 2200/12; B01L 2300/0893

(57) ABSTRACT

The presently described techniques relate generally to providing motion feedback (e.g., motion system calibration and/or sample alignment) in the context of an imaging system (such as a time delay and integration (TDI) based imaging system). The architecture and techniques discussed may achieve nanoscale control and calibration of a movement feedback system without a high-resolution encoder subsystem or, in the alternative embodiments, with a lower resolution (and correspondingly less expensive) encoder subsystem than might otherwise be employed. By way of example, certain embodiments described herein relate to ascertaining or calibrating linear motion of a sample holder surface using nanoscale features (e.g., sample sites or nanowells or lithographically patterned features) provided on a surface of the sample holder.

### CROSS REFERENCE TO RELATED APPLICATION

This application claims priority from and the benefit of U.S. Provisional Application Ser. No. 63/369,563, entitled “FLOW CELL BASED MOTION SYSTEM CALIBRATION AND CONTROL METHODS”, filed Jul. 27, 2022, which is hereby incorporated by reference in its entirety for all purposes.

### TECHNICAL FIELD

The present approach relates generally to the use of nanoscale patterning present on a flow cell as part of a feedback mechanism for assessing or calibrating motion, position, and/or orientation of the flow cell during imaging. In accordance with this approach, the imaging system may operate without an encoder system (e.g., a linear encoder system) typically used to provide motion data and/or or may utilize an encoder system having reduced specifications (e.g., lower resolution or accuracy) and correspondingly lower costs.

### BACKGROUND

In a nucleic acid sequencing context a sample holder, such as a flow cell or other sequencing substrate, for use in a sequencing instrument may provide a number of individual sites (e.g., sample wells or nanowells) at permanently or transiently fixed locations on a surface. Such sites may contain chemical groups or biological molecules, which can be identical or different among the many sites, and can interact with other materials of interest, such as a biological sample. Sites can be located and/or analyzed by taking an image of the substrate surface, such as by taking a planar image or by line scanning. The image data may be processed to locate and identify at least a portion of the sites and/or to obtain qualitative or quantitative measurements related to samples being analyzed. In such a context, where a chemical or biological interaction occurs at a particular site, the interaction may be detected at the site and correlated with the location and identity of the site, as well as the particular chemical group or molecule present at the site.

In a biological molecule sequencing context employing such substrates, sequencing instruments using a scanning imaging system may be used to generate high-quality images of the sequencing substrate, with the sequencing data quality typically corresponding to the quality of the images. In practice, the scanning imaging system may be a time delay and integration (TDI) imaging system that employs a TDI charge-coupled device (CCD) as an image sensor, which allows line images to be captured of moving objects (e.g., a moving sequencing substrate or flow cell surface) even at low-light levels. In such a system, generated charge or signal associated with a given moving point on the surface is accumulated over a time interval (e.g., through a succession of line images) so that, even though the point has moved (e.g., undergone motion in a scan direction) during scanning, signals generated by a respective point within the time interval can be accumulated or summed so to generate a stronger signal than might be detected at a single instant in time. In this manner, a substrate or surface containing multiple sample sites or locations may be imaged while undergoing a linear motion and good signal quality obtained for the sample sites or locations.

As may be appreciated, in practice such a TDI imaging system used in a sequencing context requires very accurate and precise scanning controls and motion systems, which may be expensive in a commercial or real-world context. In particular, in the context of an imager suitable for use in a sequencing system, nanoscale encoder feedback systems may be necessary to relate linear motion of the imaged surface, such as a flow cell, with the operation of the TDI charge-coupled device. Further, such high-performance motion systems typically require precise calibration to function properly, which in turn may depend on relatively expensive structures (e.g., nanoscale structures or grating) provided as calibration targets for the encoder feedback system.

### SUMMARY

The present techniques provide a time delay and integration (TDI) based sequencing imaging system or architecture for scanning a substrate having nanoscale features, such as nanowells suitable for sample processing, or other features discernible during a scan operation, such as fluorescing or reflective lithographically patterned features. In one embodiment, the encoder typically present in such a TDI imaging system as part of the scanning control subsystem (e.g., the motion feedback subsystem) is absent. However, in accordance with the techniques described herein, the scanning control subsystem of the TDI imaging system still obtains nanoscale control and calibration feedback even in the absence of the encoder sub-system. Alternatively, in other embodiments, the encoder employed may be of a lower accuracy or resolution than might otherwise be employed to achieve the desired nanoscale control and calibration. In certain embodiments, the presently described techniques may employ specialized nanoscale patterning in addition to or instead of the nanoscale features already present on the flow cell to monitor, control, calibrate, or adjust motion feedback and/or signal integration. In certain embodiments, the present techniques do not require that viable clusters be formed prior to aligning the system, allowing direct flow cell pattern imaging to be used to perform alignment and calibration, which allows sample generation (e.g., cluster formation) to be performed in parallel with alignment and calibration processes.

As may be further understood in view of the present description, the present techniques also include or otherwise provide for an article of manufacture, comprising a substrate, on which a plurality of sample sites are disposed at fixed, physical locations on the surface of the substrate. An example of such an article may include a patterned arrangement of sample sites associated with a sequencing flow cell, where some or all of the sites may be configured to hold a material of interest. Alternatively, the article of manufacture may comprise one or more layers, coatings, and so forth from which a pattern may be ascertained upon imaging. In either such embodiment, the nanoscale features or pattern may be imaged (such as using a near-infrared (NIR) beam or other exposure) and motion-control feedback signals or data ascertained from the imaged patterns or features.

With the preceding in mind, a respective embodiment of a patterned flow cell is provided. In accordance with this embodiment, the patterned flow cell comprises: a substrate and a first plurality of sample sites formed in the substrate. The first plurality of sample sites are arranged in a periodic pattern such that regions of the first plurality of sample sites are spaced apart at periodic intervals. The first plurality of sample sites have a first value for a geometric parameter characterizing each sample site of the first plurality of sample sites. The patterned flow cell further comprises a second plurality of sample sites formed in the substrate. Regions of the second plurality of sample sites are arranged in the periodic pattern alternating with regions of the first plurality of sample sites. The second plurality of sample sites have a second value for the geometric parameter characterizing each sample site of the second plurality of sample sites. In various embodiments the substrate comprises a glass substrate. In the same or other embodiments the first plurality of sample sites and the second plurality of sample sites each comprise nanowells and the geometric parameter comprises depth or diameter of the nanowells. In the same or other embodiments the first plurality of sample sites and the second plurality of sample sites vary by a second geometric parameter, such as diameter when depth is the first geometric parameter. In the same or other embodiments the periodic intervals are less than a diameter or width of one or more beams emitted by a focusing sub-system configured to scan the patterned flow cell.

In a further embodiment a patterned flow cell is provided. In practice, such a patterned flow cell may include multiple distinct layers as well as gaps or channels formed within or between such layers and through which fluid may flow. By way of example, such a flow cell may comprise a functional layer on which functional features (e.g., nanowells) are formed as well as a substrate layer to which the functional layer is attached or formed on. As discussed herein, an encoder layer may also be formed on or as part of the functional layer (such as on a surface opposite the functional features, such as nanowells), on or in one of the surfaces of the substrate layer (e.g., a first surface of the substrate facing the functional layer or a second surface of the substrate layer opposite the functional layer), or as an entirely separate layer distinct from the functional layer or the substrate layer. By way of example, in accordance with this embodiment, the patterned flow cell may comprise a functional layer and a plurality of sample sites formed on a first surface of the functional layer. The patterned flow cell further comprises a plurality of features formed opposite the first surface. The plurality of features may be formed on a second surface of the functional layer opposite the first surface, on a substrate layer separate from the functional layer and provided opposite of the first surface, or as part of an encoder layer provided separate from the functional layer and the substrate layer. The features of the plurality of features are spaced apart at periodic intervals in a scanning direction associated with the flow cell. The plurality of features reflect or fluoresce in the presence of wavelengths different than those employed by the imager sub-system. By way of example, the plurality of features may reflect or fluoresce in the presence of emissions in the near-infrared wavelength range, or even at wavelengths less than 700 nm, such as may be employed by the focusing sub-system but not typically employed by the imager sub-system. In various embodiments one or both of the functional layer or the substrate layer comprise glass. In the same or other embodiments the periodic intervals are less than a diameter or width of one or more beams emitted by a focusing sub-system configured to scan the patterned flow cell. In the same or other embodiments the plurality of features are lithographically patterned features formed on, within, or between one or both of the functional layer and the substrate layer. In the same or other embodiments the patterned flow cell further comprises an additional plurality of features that run continuously or intermittently in the scanning direction associated with the flow cell and are spaced apart in a cross-sample direction perpendicular to the scanning direction and wherein the plurality of additional features reflect or fluoresce in the presence of wavelengths not employed by the imager sub-system, such as those that may be employed instead by the focusing sub-system.

In a further embodiment, a sequencing instrument is provided. In accordance with this embodiment, the sequencing instrument comprises: a sample stage configured to support a flow cell; an imager sub-system comprising an objective lens, a photodetector, and a light source configured to operate in combination to image the flow cell when present on the sample stage; a focusing sub-system comprising one or more focusing light sources or emitters (e.g., superluminescent diodes (SLEDs) in certain contexts) and one or more focusing detectors, wherein the one or more focusing light sources or emitters operate at wavelengths different from wavelengths used by the imager sub-system; and a controller configured to perform operations comprising: linearly translating the sample stage holding the flow cell during a scanning operation; using the imager sub-system, line scanning a plurality of sample sites formed in a top surface of a functional layer of the flow cell while the flow cell is linearly translated; continuously or intermittently scanning the sample container with the one or more beams emitted by the focusing sub-system while the flow cell is linearly translated; using the one or more focusing detectors, acquiring modulated intensity data over time in response to the one or more beams emitted by the focusing sub-system interacting with a plurality of periodically spaced apart features formed on the flow cell; deriving at least a linear translation velocity of the flow cell based on the modulated intensity data; and adjusting or calibrating one or both of a relative stage motion associated with linearly translating the flow cell or a signal integration performed on intensity data measured for the sample sites as part of line scanning the plurality of sample sites. In certain embodiments the plurality of periodically spaced apart features formed on the flow cell comprise first and second regions of sample sites of the plurality of sample sites, wherein the first and second regions of sample sites vary periodically with respect to at least one geometric parameter in a scanning direction associated with linearly translating the flow cell. In other embodiments the plurality of periodically spaced apart features are formed on a bottom surface of the functional layer opposite the top surface, on a substrate layer separate from the functional layer, or on a separate layer from either the functional layer or the substrate layer. The features of the plurality of periodically spaced apart features are spaced apart at a periodic interval in a scanning direction associated with linearly translating the flow cell. In one such embodiment the features of the plurality of periodically spaced apart features reflect or fluoresce in the presence of the energy wavelengths emitted by the one or more focusing light sources or emitters (e.g., superluminescent diodes (SLEDs).

### BRIEF DESCRIPTION OF THE DRAWINGS

These and other features, aspects, and advantages of the present invention will become better understood when the following detailed description is read with reference to the accompanying drawings, in which like characters represent like parts throughout the drawings, wherein:

FIG. 1 illustrates a high-level overview of one example of an image scanning system, in accordance with aspects of the present disclosure;

FIG. 2 is a block diagram illustration of an imaging and image processing system, such as for biological samples, in accordance with aspects of the present disclosure;

FIG. 3 is a diagrammatical overview of functional components that may be included in a data analysis system for use in a system of the type illustrated in FIG. 2;

FIG. 4 is a cut-away diagram illustrating sites on an example patterned flow cell surface, in accordance with aspects of the present disclosure;

FIG. 5 depicts a sectional view of a portion of a flow-cell illustrating sample sites (e.g., nanowells) having different depth characteristics, in accordance with aspects of the present disclosure;

FIG. 6 is a process flow illustrating steps for generating linear translation data based on modulated signal intensity measured over time, in accordance with aspects of the present disclosure;

FIG. 7 depicts a plan view and sectional view taken along view line A-A illustrating a patterned layer applied to a flow cell for use in determining translation parameters of the flow cell during imaging, in accordance with aspects of the present disclosure;

FIG. 8 depicts a sectional view of a flow cell and illustrates a patterned layer of reflective material for use in determining translation parameters of the flow cell during imaging, in accordance with aspects of the present disclosure

FIG. 9 is a process flow illustrating steps for generating a patterned layer on a flow cell using lithographic techniques, in accordance with aspects of the present disclosure;

FIG. 10 depicts a plan view, and corresponding line sensor outputs, illustrating a patterned layer applied to a flow cell for use in determining translation parameters of the flow cell during imaging, in accordance with aspects of the present disclosure;

FIG. 11 depicts a plan view illustrating a patterned layer applied to a flow cell for use in determining translation parameters of the flow cell during imaging, in accordance with aspects of the present disclosure;

FIG. 12 depicts a plan view illustrating a patterned layer applied to a flow cell for use in determining translation parameters of the flow cell during imaging, in accordance with aspects of the present disclosure; and

FIG. 13 depicts a plan view illustrating an alternative embodiment of a patterned layer applied to a flow cell for use in determining translation parameters of the flow cell during imaging, in accordance with aspects of the present disclosure.

### DETAILED DESCRIPTION

Methods and systems described herein provide for motion feedback (e.g., motion system calibration and/or sample alignment) in the context of an imaging system (such as a time delay and integration (TDI) based imaging system) that may be used in nucleic acid sequencing or other nanoscale-feature imaging and processing operations. The architecture and techniques discussed herein achieve nanoscale control and calibration of a movement feedback system without a high resolution (and correspondingly expensive) encoder subsystem or, in the alternative embodiments, with a lower resolution (and correspondingly less expensive) encoder subsystem than might otherwise be employed. In particular, this is accomplished by using nanoscale patterns or features (e.g., nanowells or other nanoscale features) present on the imaged substrate (e.g., flow cell surface) as part of the nanoscale motion-feedback system. By way of example, in one nucleic acid sequencing embodiment a pattern (e.g., a specialized or distinctive pattern) of nanowells on a flow cell is used to derive motion feedback for the sequencing imager using existing imaging components of the imager and not using an encoder. In other examples, reflective or fluorescing features formed in or on the imaged substrate may be used to derive such motion feedback using existing imaging components.

As described herein, in the context of nucleic acid sequencing the presently described techniques do not rely on viable sequencing clusters for image data used to align the optical features and/or synchronize the optical and motion subsystems. In particular, prior approaches can be problematic to the extent they utilize patterns made using actual sequencing clusters to create alignment targets and, therefore, assume successful cluster generation, which in turn requires the successful completion of multiple pre-run sequencing processes. Further, imaging alignment using such prior approaches may depend on weak cluster emission light to be imaged, which can degrade the quality and robustness of the alignment process due to poor signal strength or signal-to-noise ratio. Conversely, the alignment and calibration techniques described herein do not depend on or otherwise utilize viable sequencing clusters and instead enable direct flow cell pattern imaging to perform alignment and calibration operations. Further, such alignment and calibration operations can be performed as soon as a sample flow cell is loaded into the system, allowing these processes to be completed in parallel with sample generation and thereby reducing overall sequencing run time.

As discussed herein, the described techniques allow, among other things, next generation sequencing (NGS) instruments to be employed without the additional cost and complexity of separate motion feedback systems (e.g., encoders). Further, in addition to the technical benefit of being able to omit the encoder system (with the corresponding cost and complexity benefits) while still achieving effective alignment and motion calibration, the flow cell based feedback approach described herein can provide improved performance relative to conventional approaches as there is no abstraction of the motion measurement away from the sample being imaged, as occurs in encoder-based motion feedback systems. In addition, as discussed herein higher effective resolutions can be achieved using patterns or configurations of sites (e.g., nanowells) that allow or improve registration of positions in both the x-dimension (i.e., the cross-sample dimension on a two-dimensional sample substrate) and the y-dimension (i.e., the scanning axis of the sample or direction of linear motion of the sample substrate).

In certain embodiments discussed herein, a focus tracking module provided as a sub-system of an imager system (e.g., nucleic acid sequencer) may be utilized for the additional purpose of generating motion feedback and calibration data for the motion sub-system. By way of example, a light source or other emitter (e.g., a superluminescent diode (SLED)) employed as part of such a focus tracking sub-system may additionally be employed to scan features provided on the scanned sample substrate (e.g., nanowells in which a sample is being analyzed, lithographically patterned features or layers, and so forth) so as to derive motion feedback data. Such an emitter used by the focus tracking sub-system may employ wavelengths different than those employed by the imager sub-system and which, by way of example may be within the infrared or near-infrared wavelength range. As used herein, the infrared spectrum may be understood to generally correspond to wavelengths between 700 nm and 1 mm and the near-infrared spectrum may be understood to generally correspond to wavelengths between 0.7 and 2.5 μm. In certain embodiment the focus tracking sub-system may employ wavelengths less than 700 nm, which may also be understood to be different than those wavelengths employed by the imaging sub-system. For example, as discussed in greater detail herein, scaled patterns, including repeated and periodic patterns, formed either lithographically or based on variations in the sample sites themselves, may be integrated as part of the sample holder (e.g., as part of one or more layers of a flow cell). When illuminated by the focus sub-system during a scan operation such features of the sample holder (e.g., a flow cell) may generate measured intensity data (e.g., reflectance or fluorescence data) that is modulated based on the pattern and that may be processed to derive one or more velocity (e.g., linear motion velocity), position (e.g., in an x- and/or y-dimension), rotation, skew, or other feedback data that may be employed to adjust or calibrate a motion sub-system in real time such that relative motion of the sample holder may be adjusted or corrected on-the-fly. Further, such derived data may be used as part of the image or data processing as well, such as to calibrate a signal integration step in a TDI scanning operation. By way of further example, the nanoscale pattern of features being interrogated (either by means of a spot or line sensor arrangement) may result in destructive interference patterns in the presence of the focus tracker illumination wavelength, which can be employed in evaluating motion or position of the sample substrate during the scan operation.

With the preceding in mind, and by way of further background, as discussed herein patterned surfaces may be provided as part of a sample holder or sample holder layer or substrate, the processing of which produces image data, or other forms of detection output, of sites on the surface. By way of example, such a sample holder may be a type of analytical sample holder, such as those used for the analysis of biological samples. Such patterned surfaces may contain repeating patterns of features (e.g., sample sites, such as sample wells or nanowells, or patterned lithographic features in a deposited layer of the substrate) that are to be resolved at a suitable resolution (e.g., sub-micron resolution ranges) for which the methods and systems described herein are suited. In many applications, the sample material to be imaged and analyzed will be located on a surface of the sample holder which may be formed using a glass material or a multi-layer substrate. Various chemical or structural features may be employed at sample sites to bind or anchor (or to otherwise localize) segments or fragments of material to be processed (e.g., hybridized, combined with additional molecules, imaged, and analyzed). Fiducial markers or regions, or simply “fiducials” are typically located at known locations with respect to the sites to assist in locating the support in the system (e.g., for imaging), and for locating the sites in subsequent image data.

As discussed in greater detail below, sequencing instruments that employ a scanning imaging system (e.g., an imager) typically move the imaged sample holder and imaging optics relative to one another during operation. In practice, the imaged sample holder may be a flow cell. As used herein, a “flow cell”, which may also be referred to as “sequence flow cells” or “patterned flow cells”, may be understood to be a sample holding and/or processing structure or device. Such devices comprise sites (i.e., sample sites or binding sites) at which analytes may be located for processing and analysis.

As further discussed herein, in a nucleic acid sequencing technique, oligomeric or polymeric chains of nucleic acids, which may be spatially separated and localized on a substrate, may be subjected to several cycles of biochemical processing and imaging. In some examples, each cycle can result in one of four different labels being detected at each feature, depending upon the nucleotide base that is processed biochemically in that cycle. In such examples, multiple (e.g., four) different images are obtained at a given cycle and each feature will be detected in the images. Sequencing includes multiple cycles, and alignment of features represented in image data from successive cycles is used to determine the sequence of nucleotides at each site based on the sequence of labels detected at the respective site. In a time delay and integration (TDI) imaging system, the imaging of each location may be performed over a time interval while the substrate undergoing motion undergoes relative linear motion with respect to the imaging components, with the observed signal attributed to a given sample site or location being integrated or summed based on the known relative linear motion of the surface over time. By integrating signals in this manner, a stronger signal may be generated for a given sample site, even in the presence of a respectively weak observed signal. To perform the signal integration, however, very accurate scanning controls and knowledge of the actual motion of the sample surface is needed so that signals acquired at different times are integrated properly.

Several examples will be described herein for ascertaining or calibrating linear motion of a sample holder surface using nanoscale features (e.g., sample sites or nanowells or lithographically patterned features) provided on an internal or external surface or layer of the sample holder. It will be understood that systems are also provided for carrying out the methods in an automated or semi-automated way, and such systems will include a processor; a data storage device; and a program for image analysis, the program including instructions for carrying out one or more methods provided for processing or leveraging motion and/or rotational data, such as signal integration, image registration, distortion correction, and so forth. Accordingly, methods discussed herein can be carried out on a computer, for example, having components and executable routines needed for such purposes.

The methods and systems described herein may be employed for analyzing any of a variety of materials, such as biological samples and molecules, which may be on or in a variety of objects. Useful objects are solid supports or solid-phase surfaces with attached analytes. The methods and systems set forth may provide advantages when used with objects having a repeating pattern of features in an x, y plane, such as a patterned flow cell having an attached collection of molecules, such as DNA, RNA, biological material from viruses, proteins, antibodies, carbohydrates, small molecules (such as drug candidates), biologically active molecules, or any other analytes of interest.

An increasing number of analytic and diagnostic applications have been developed using substrates with patterned arrangements of features (e.g., sample wells or sites) for attaching or processing biological molecules, such as nucleic acids and polypeptides. Such patterned features may include bound DNA or RNA probes. These are specific for nucleotide sequences present in plants, animals (e.g., humans), and other organisms. In some applications, for example, individual DNA or RNA probes can be attached at individual features of a surface of a patterned flow cell. A test sample, such as from a known or unknown person or organism, can be exposed to the sites, such that target nucleic acids (e.g., gene fragments, mRNA, or amplicons thereof) hybridize to complementary probes at respective sites in the pattern of sites. The probes can be labeled in a target specific process, such as using labels present on the target nucleic acids or due to enzymatic labeling of the probes or targets that are present in hybridized form at the features. The patterned surface can then be examined, such as by scanning specific frequencies of light over the features to identify which target nucleic acids are present in the sample.

Patterned flow cells may be used for genetic sequencing and similar applications. In general, genetic sequencing includes determining the order of nucleotides in a length of target nucleic acid, such as a fragment of DNA or RNA. Relatively short sequences may be sequenced at each feature, and the resulting sequence information may be used in various bioinformatics methods to logically fit the sequence fragments together, so as to reliably determine the sequence of much more extensive lengths of genetic material from which the fragments are available. Automated, processor-executable routines for characterizing fragments may be employed, and have been used in endeavors such as genome mapping, identification of genes and their function, and so forth. Patterned arrangements of sample sites on a surface are useful for characterizing genomic content because a large number of variants may be present and this supplants the alternative of performing many experiments on individual probes and targets. Thus, the patterned surface (such as a patterned surface of a flow cell) may be a useful platform for performing such investigations in a practical manner.

Patterned surfaces used for nucleic acid sequencing often have random spatial patterns of nucleic acid features. For example, HiSeg™ or MiSeg™ sequencing platforms available from Illumina Inc. utilize flow cells comprising supports (e.g., surfaces) upon which nucleic acid(s) is/are disposed by random seeding followed by bridge amplification. However, patterned surfaces (upon which discrete reaction sites are formed in a pattern on the surface) can also be used for nucleic acid sequencing or other analytical applications. Example patterned surfaces, methods for their manufacture and methods for their use are set forth in U.S. Pat. Nos. 9,512,422; 8,895,249; and 9,012,022; and in U.S. Pat. App. Pub. Nos. 2013/0116153 A1; and 2012/0316086 A1, each of which is incorporated herein by reference in its entirety. The features (e.g., reaction or capture sites or wells) of such patterned surfaces can be used to capture a single nucleic acid template molecule to seed subsequent formation of a homogenous colony, for example, via bridge amplification. Such patterned surfaces are useful for nucleic acid sequencing applications.

The size of features, such as reaction or sample binding sites (e.g., sample wells or nanowells) on a patterned surface (or other patterned features used in a method or system as described herein), can be selected to suit a desired application. In some non-limiting examples, a sample site feature of a patterned surface can have a size that accommodates only a single nucleic acid molecule. A surface having a plurality of features in this size range is useful for constructing a pattern of molecules for detection at single molecule resolution. Features in this size range are also useful in patterned surfaces having features that each contain a colony of nucleic acid molecules. Thus, the features of a patterned surface can each have an area that is no larger than about 1 mm², no larger than about 500 μm², no larger than about 100 μm², no larger than about 10 μm², no larger than about 1 μm², no larger than about 500 nm², no larger than about 100 nm², no larger than about 10 nm², no larger than about 5 nm², or no larger than about 1 nm². Alternatively or additionally, the features of a patterned surface will be no smaller than about 1 mm², no smaller than about 500 μm², no smaller than about 100 μm², no smaller than about 10 μm², no smaller than about 1 μm², no smaller than about 500 nm², no smaller than about 100 nm², no smaller than about 10 nm², no smaller than about 5 nm², or no smaller than about 1 nm². Indeed, a feature can have a size that is in a range between an upper and lower limit selected from those exemplified above. Although several size ranges for features of a surface have been exemplified with respect to nucleic acids and on the scale of nucleic acids, it will be understood that features in these size ranges can be used for applications that do not include nucleic acids. It will be further understood that the size of the features need not necessarily be confined to a scale used for nucleic acid applications.

For examples that include an object (e.g., a flow cell surface) having a plurality of features, the features (e.g., sample sites) can be discrete, being separated with spaces between each other. A patterned flow cell surface useful in the present context can have sample sites (e.g., nanowells) that are separated by edge to edge distance of at most about 100 μm, about 50 μm, about 10 μm, about 5 μm, about 1 μm, about 0.5 μm, or less. Alternatively or additionally, a patterned surface can have sample sites that are separated by an edge to edge distance of at least about 0.5 μm, about 1 μm, about 5 μm, about 10 μm, about 50 μm, about 100 μm, or more. These example ranges are provided by way of context, are non-limiting, and can apply to the average edge to edge spacing for sample sites, as well as to the minimum or maximum spacing.

The size of the sample sites and/or pitch of the sample sites can vary such that the sample sites on a patterned surface can have a desired density. For example, the average sample site pitch in a regular pattern can be at most about 100 μm, about 50 μm, about 10 μm, about 5 μm, about 1 μm, about 0.5 μm, or about 350 nm, or less. Alternatively or additionally, the average sample site pitch in a regular pattern can be at least about 0.5 μm, about 1 μm, about 5 μm, about 10 μm, about 50 μm, or about 100 μm or more. These ranges can apply to the maximum or minimum pitch for a regular pattern as well. For example, the maximum sample site pitch for a regular pattern can be at most about 100 μm, about 50 μm, about 10 μm, about 5 μm, about 1 μm, or about 0.5 μm or less; and/or the minimum sample site pitch in a regular pattern can be at least about 0.5 μm, about 1 μm, about 5 μm, about 10 μm, about 50 μm, or about 100 μm or more.

The density of sample sites on a patterned surface can also be understood in terms of the number of sample sites present per unit area. For example, the average density of sample sites on a patterned surface can be at least about 1×10³ sample sites/mm², about 1×10⁴ sample sites/mm², about 1×10⁵ sample sites/mm² about 1×10⁶ sample sites/mm², about 1×10⁷ sample sites/mm², about 1×10⁸ sample sites/mm², or about 1×10⁹ sample sites/mm² or higher. Alternatively or additionally, the average density of sample sites on a patterned surface can be at most about 1×10⁹ sample sites/mm², about 1×10⁸ sample sites/mm², about 1×10⁷ sample sites/mm², about 1×10⁶ sample sites/mm², about 1×10⁵ sample sites/mm², about 1×10⁴ sample sites/mm², or about 1×10³ sample sites/mm² or less.

The sample sites provided on a patterned surface can have any of a variety of shapes, cross-sections, and layouts. For example, when observed in a two-dimensional plane, such as on a surface, the sample sites can have a perimeter that is rounded, circular, oval, rectangular, square, symmetric, asymmetric, triangular, polygonal, or the like. The sample sites can be arranged in a regular repeating pattern including, for example, a hexagonal or rectilinear pattern. A pattern can be selected to achieve a desired level of packing. For example, round sample sites are optimally packed in a hexagonal arrangement. Other packing arrangements can also be used for round features and vice versa.

In general, a patterned surface might be characterized in terms of the number of sample sites that are present in a subset that forms the smallest geometric unit of the pattern. The subset can include, for example, at least 2, 3, 4, 5, 6, 10 or more sample sites. Depending upon the size and density of the sample sites, the geometric unit can occupy an area of less than about 1 mm², about 500 μm², about 100 μm², about 50 μm², about 10 μm², about 1 μm², about 500 nm², about 100 nm², about 50 nm², or about 10 nm² or less. Alternatively or additionally, the geometric unit can occupy an area of greater than about nm², about 50 nm², about 100 nm², about 500 nm², about 1 μm², about 10 μm², about μm², about 100 μm², about 500 μm², or about 1 mm² or more. Characteristics of the sample sites in a geometric unit, such as shape, size, pitch and the like, can be selected from those set forth herein more generally with regard to sample sites provided on a patterned surface.

A surface having a regular pattern of sample sites can be ordered with respect to the relative locations of the sample sites but random with respect to one or more other characteristic of each sample site. For example, in the case of a nucleic acid sequencing surface, the nucleic acid sample sites can be ordered with respect to their relative locations but random with respect to one's knowledge of the sequence for the nucleic acid species present at any sample site. As a more specific example, nucleic acid sequencing surfaces formed by seeding a repeating pattern of sample sites (e.g., nanowells) with template nucleic acids and amplifying the template at each feature to form copies of the template at the sample site (e.g., via cluster amplification or bridge amplification) will have a regular pattern of nucleic acid sample sites but will be random with regard to the distribution of sequences of the nucleic acids across the pattern. Thus, detection of the presence of nucleic acid material on the surface can yield a repeating pattern of features, whereas sequence specific detection can yield non-repeating distribution of signals across the surface.

As may be appreciated, the description of patterns, order, randomness and so forth provided herein not only pertains to sample sites on objects (e.g., a solid substrate having such sample sites, such as sample sites on solid-supports or surface), but also to image data, or images generated from such image data, that includes or depicts such an object having features as described herein. As such, patterns, order, randomness and so forth can be present in any of a variety of formats that are used to store, manipulate or communicate image data including, but not limited to, a computer readable medium or computer component such as a graphical user interface or other output device.

As discussed above and throughout, patterned flow cells in accordance with the presently described techniques, have a regular pattern of sample sites (e.g., wells or nanowells) imprinted in a respective surface of a layer (e.g., a functional layer) of the flow cell. This pattern is normally hexagonal or square, and can have different orientations. In practice, a hexagonal pattern is conventionally used in current systems that employ a linear scanning imaging system. In such contexts, the hexagonal pattern may typically have one axis aligned at right angles to the scanning direction, y (i.e., the scanning axis of the sample substrate along which the substrate is typically linearly advanced during a scan operation). This cross-sample direction or axis (i.e., the x-dimension) is typically referred to as “horizontal” due to how images are normally presented with the image vertical axis being aligned with the scanning direction (i.e., the y-dimension). In practice, linear images may be acquired during a scan operation in the x-dimension, with the substrate being moved continuously or stepwise in the y-dimension (i.e., the scanning direction) so as to allow a surface to be imaged. In this context, and as further noted below, the z-dimension is orthogonal to both the x- and y-dimensions and corresponds to depth in such an imaging geometry. Location of the individual wells is typically made possible by using fiducials in known locations on the flow cell pattern.

As discussed herein, in accordance with various implementations certain flow cell features (e.g., sample nanowells or lithographically patterned features) may themselves be used as part of a linear motion control and calibration feedback system. By way of example, in certain embodiments the patterning of the nanowells or other features may be employed as part of the motion feedback analysis. This is in contrast to prior approaches in which patterns observed via actual sequencing clusters were employed to create alignment targets that are imaged by the scanning instrument to align the sample flow cell to the instrument's optical system. While such approaches have been sufficient in certain contexts, they require the presence of viable sequencing clusters in order to align the system, which may be problematic to the extent that this assumes successful cluster generation, which in turn typically requires the successful completion of multiple pre-run sequencing processes so as to establish viable, visible sequencing clusters. Further, the prior imaging alignment approach is typically based on relatively weak cluster emission light due to being performed at an early or pre-stage of sequencing, which can degrade or otherwise negatively impact the quality and robustness of the alignment process.

In contrast, the techniques discussed herein enable direct imaging of flow cell patterned features (i.e., without sequencing cluster formation or emission) to perform alignment and calibration. Further, the presently described approaches can be performed as soon as the sample flow cell is loaded into the imager system. This allows the lengthy alignment and/or calibration processes to be completed in parallel with sample generation (i.e., cluster formation), thereby reducing overall sequencing run time. Further, the techniques discussed herein may be performed without a nanoscale encoder feedback sub-system. Such encoder sub-systems add cost and complexity to the overall sequencing imager system. Conversely, the presently disclosed techniques may utilize one or more aspects or components (such as an infrared (IR) or near-infrared (NIR) emitter(s) (e.g., superluminescent diodes (SLEDs) and detector(s)) of the focus tracking module or sub-system) of the sequencing imager system. Conversely, in other embodiments, a linear encoder may still be present or employed for linear motion feedback, but such a linear encoder may be of a lower resolution or scale (and correspondingly less expensive) than would otherwise be used to generate motion feedback and/or calibration data.

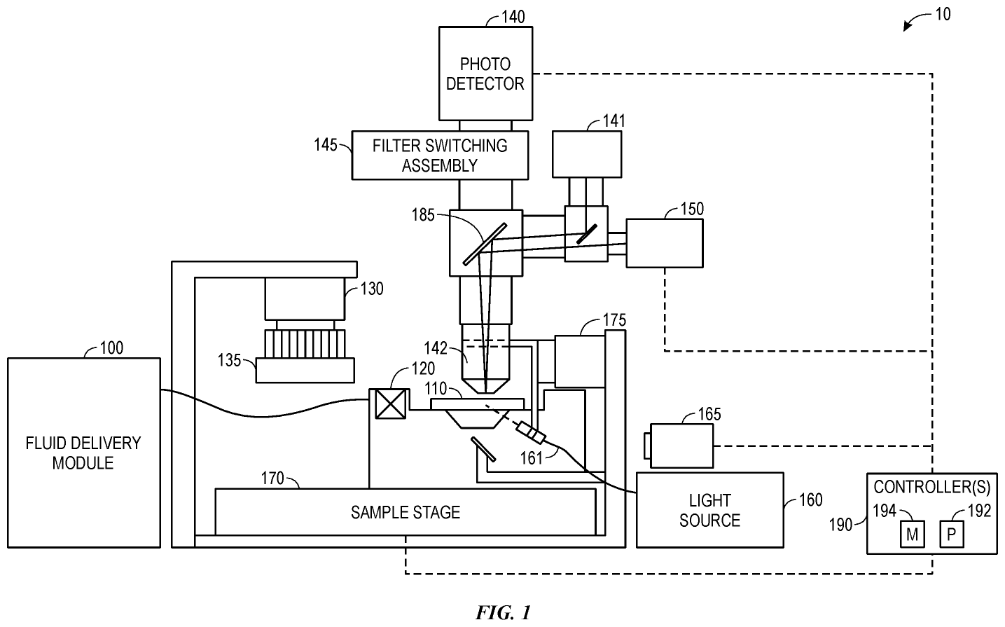

While the preceding provides useful background and context with respect to terminology and processes, the following provides an example of suitable systems and functional workflows that may utilize or process sample substrates using motion feedback techniques and sub-systems as described herein. By way of example, FIG. 1 depicts an example of an optical image scanning system 10, such as a sequencing system, that may be used in conjunction with the disclosed motion feedback and calibration techniques to process biological samples. With respect to such an imaging system 10, it may be appreciated that such imaging systems typically include a sample stage or support that holds a sample or other object to be imaged (e.g., a flow cell or sequencing cartridge having a patterned surface of spaced apart sample sites, such as sample wells) and an optical stage that includes the optics used for the imaging operations.

Turning to FIG. 1, the example imaging scanning system 10 may include a device for obtaining or producing an image of a region of a sample holder or substrate, such as line image data of a flow cell acquired as the flow cell is linearly displaced. The example illustrated in FIG. 1 shows an example image scanning system configured in a backlit operational configuration, though a frontlit configuration may alternatively be employed. In the depicted example, subject samples are located on sample holder 110 (such as a flow cell), which is positioned on a sample stage 170 under an objective lens 142. Light source 160 and associated optics direct a beam of light to a chosen sample location on the sample holder 110. The sample fluoresces and the resultant light is collected by the objective lens 142 and directed to a photodetector 140 to detect the florescence. Sample stage 170 is moved relative to objective lens 142 to position the next sample location on sample holder 110 at the focal point of the objective lens 142. Movement of sample stage 170 relative to objective lens 142 can be achieved by moving the sample stage itself, the objective lens, the entire optical stage, or any combination of these structures. Further examples may also include moving the entire imaging system over a stationary sample.

A fluid delivery module or device 100 directs a flow of reagents (e.g., fluorescent nucleotides, buffers, enzymes, cleavage reagents, etc.) to (and through) the sample holder 110 and waste valve 120. In some applications, the sample holder 110 can be implemented as a flow cell that includes clusters of nucleic acid sequences at a plurality of sample locations on a layer of the sample holder 110. The samples to be sequenced may be attached to the substrate of the flow cell, along with other optional components. In practice, the plurality of sample locations provided on a surface of the flow cell may be arranged as spaced apart sample sites (e.g., wells or nanowells), which in turn may be subdivided into tile, sub-tile, and line regions each comprising a corresponding subset of the plurality of sample locations.

The depicted example image scanning system 10 also comprises temperature station actuator 130 and heater/cooler 135 that can optionally regulate the temperature or conditions of the fluids within the sample holder 110. A camera system (e.g., photodetector system 140) can be included to monitor and track the sequencing of sample holder 110. The photodetector system 140 can be implemented, for example, as a CCD camera, which can interact with various filters within filter switching assembly 145, objective lens 142, and focusing sub-system assembly (e.g., focusing emitter 150 and focusing detector 141). The photodetector system 140 is not limited to a CCD camera and other cameras and image sensor technologies can be used.

With respect to the presently described techniques, in certain implementations aspects of the focusing sub-system comprising one or both of the focusing emitter 150 and/or the focusing detector 141 may be employed as part of a motion feedback system. By way of example, and as discussed herein, components of the focusing sub-system may be employed to interrogate the pattern of sample sites present on the substrate being scanned prior to or during the scan operation so as to generate data used by the motion feedback system to control relative linear motion of the substrate during the scan operation and/or to facilitate integration of the scanned image data subsequent to the scan operation. By way of example, in a time delay and integration (TDI) based image scanner, such as a line imager, such motion feedback data may be employed in real-time or near real-time to control linear motion of the scanned substrate so to allow the precise position encoding needed for signal integration over the imaging window. In such contexts, a separate and distinct encoder feedback system may be omitted or, if present, may operate at a reduced resolution relative to what would otherwise be employed for TDI imaging.

Light source 160 (e.g., an excitation light emitter within an assembly optionally comprising multiple emitters) or another light source can be included to illuminate fluorescent sequencing reactions within the samples via illumination through a fiber optic interface 161 (which can optionally comprise one or more re-imaging lenses, a fiber optic mounting, etc.). Low watt lamp 165 and reverse dichroic 185 are also presented in the example shown.

Although illustrated as a backlit device, other examples may include a light from a light source that is directed through the objective lens 142 onto the samples on sample holder 110 (i.e., a frontlit configuration). Sample holder 110 can be mounted on a sample stage 170 to provide movement and alignment of the sample holder 110 relative to the objective lens 142. The sample stage 170 can have one or more actuators to allow it to move in any of three directions. For example, in terms of the Cartesian coordinate system, actuators can be provided to allow the stage to move in the x-, y- and z-directions relative to the objective lens 142. This can allow one or more sample locations on sample holder 110 to be positioned in optical alignment with objective lens 142.

A focus component 175 is shown in this example as being included to control positioning of the optical components relative to the sample holder 110 in the focus direction (typically referred to as the z-axis, or z-direction). Focus component 175 can include one or more actuators physically coupled to the optical stage or the sample stage, or both, to move sample holder 110 on sample stage 170 relative to the optical components (e.g., the objective lens 142) to provide proper focusing for the imaging operation. For example, the actuator may be physically coupled to the respective stage such as, for example, by mechanical, magnetic, fluidic or other attachment or contact directly or indirectly to or with the stage. The one or more actuators can be configured to move the stage in the z-direction while maintaining the sample stage in the same plane (e.g., maintaining a level or horizontal attitude, perpendicular to the optical axis). The one or more actuators can also be configured to tilt the stage. This can be done, for example, so that sample holder 110 can be leveled dynamically to account for any slope in its surfaces.

Focusing of the system generally refers to aligning the focal plane of the objective lens 142 with the sample to be imaged at the chosen sample location. However, focusing can also refer to adjustments to the system to obtain or enhance a desired characteristic for a representation of the sample such as, for example, a desired level of sharpness or contrast for an image of a test sample. Because the usable depth of field of the focal plane of the objective lens 142 may be very small (sometimes on the order of 1 μm or less), focus component 175 closely follows the surface being imaged. Because the sample container may not be perfectly flat as fixtured in the instrument, focus component 175 may be set up to follow this profile while moving along in the scanning direction (typically referred to as the y-axis).

The light emanating from a test sample at a sample location being imaged can be directed to one or more photodetectors 140. Photodetectors can include, for example a CCD camera. An aperture can be included and positioned to allow only light emanating from the focus area to pass to the photodetector(s). The aperture can be included to improve image quality by filtering out components of the light that emanate from areas that are outside of the focus area. Emission filters can be included in filter switching assembly 145, which can be selected to record a determined emission wavelength and to block any stray light.

In various examples, sample holder 110 (e.g., a flow cell) can include one or more layers or substrates upon which the samples are provided. For example, in the case of a system to analyze a large number of different nucleic acid sequences, sample holder 110 can include one or more layers or substrates on which nucleic acids to be sequenced are bound, attached or associated. In various examples, the layers or substrate can include any inert substrate or matrix to which nucleic acids can be attached, such as for example glass surfaces, plastic surfaces, latex, dextran, polystyrene surfaces, polypropylene surfaces, polyacrylamide gels, gold surfaces, and silicon wafers. In some applications, the layer or substrate is within a channel or other area at a plurality of locations formed in a matrix or pattern across the sample holder 110.

One or more controllers 190 (e.g., processor or ASIC based controller(s)) can be provided to control the operation of a scanning system, such as the example image scanning system 10 described with reference to FIG. 1. The controller 190 can be implemented to control aspects of system operation such as, for example, focusing, stage movement and/or relative linear motion of the sample relative to the optics, and imaging operations. In various applications, the controller can be implemented using hardware, software, or a combination of the preceding. For example, in some implementations the controller can include one or more CPUs or processors 192 with associated memory 194. As another example, the controller can comprise hardware or other circuitry to control the operation. For example, this circuitry can include one or more of the following: field programmable gate arrays (FPGA), application specific integrated circuits (ASIC), programmable logic devices (PLD), complex programmable logic devices (CPLD), a programmable logic array (PLA), programmable array logic (PAL), or other similar processing device or circuitry. As yet another example, the controller can comprise a combination of this circuitry with one or more processors.

With respect to the present discussion, it may be appreciated that the one or more controllers 190 may further be configured to facilitate or perform operations related to relative motion control and calibration of the substrate being scanned during a scan operation (e.g., a TDI line scanning operation). By way of example, the controller(s) 190 may control operation of one or more focusing emitters 150 during all or part of a scan operation, may receive measurement data from one or more focusing detectors 141 in response to activation of the focusing emitter(s) 150, may perform calculations determining the motion (e.g., linear motion) velocity of the substrate based upon the measurement data generated by the focusing detector(s) 141, and/or may adjust or calibrate the relative motion or other translation parameter of the substrate during a scan operation based upon the measurement data generated by the focusing detector(s) 141. Similarly, the controller(s) 190 may control or modify processing of acquired image data (e.g., line image data) based upon the determined velocity of the substrate during a scan operation. By way of example, the calculation of an integrated signal strength for a sample site may utilize the determined velocity of the substrate during the scan operation so as to properly allocate or attribute measured signal over a given time interval to a given location on the substrate. Although motion feedback and control with respect to the movement and imaging of the sample substrate is described and discussed herein in the context of this example system, this is only one example with which these techniques might be implemented. After reading this description, one of ordinary skill in the art will understand how the systems and methods described herein can be implemented with this and other scanners, microscopes and other imaging systems.

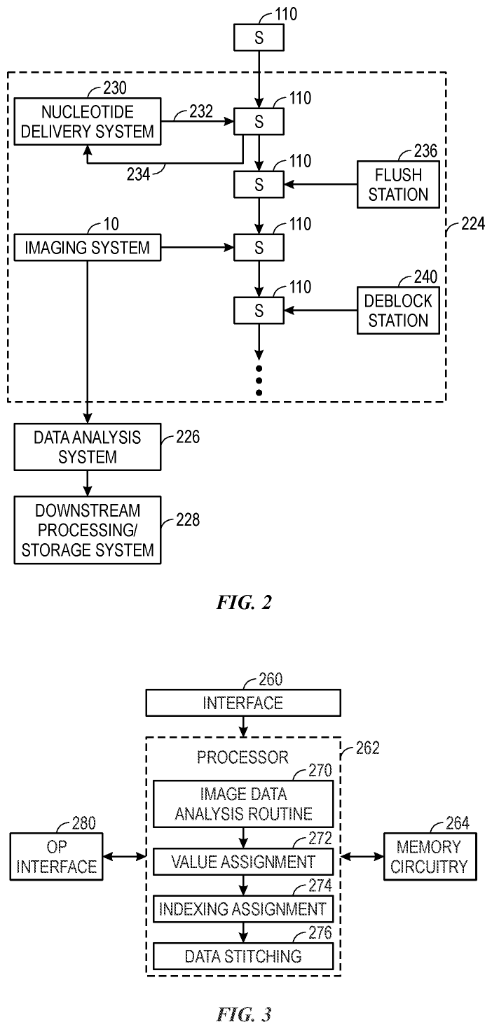

While the preceding description covers aspects of an optical image scanning system 10, such as a sequencing system, FIGS. 2 and 3 discuss the use of such a system 10 in the context of a functional work flow. This discussion is provided in order to provide useful, real-world context for the subsequent discussion of a scan operation and the use of a motion monitoring and calibration feedback system utilizing features on the surface of the substrate being scanned, as discussed herein. In this manner, it is hoped that the use and significance of the motion feedback system and techniques in the approaches subsequently described will be more fully appreciated.

With this in mind, and turning to FIG. 2, a block diagram illustrating an example work flow in conjunction with system components is provided. In this example, the work flow and corresponding system components may be suitable for processing patterned flow cells (such as for biological applications), imaging the patterned flow cell surface, and analyzing data derived from the imaging.

In the illustrated example, molecules (such as nucleotides, oligonucleotides, and other bioactive reagents) may be introduced into respective sample holder 110 that may be prepared in advance. As noted herein, such sample holders 110 may comprise flow cells, sequencing cartridges, or other suitable structures having layers or substrates encompassing sample sites for imaging. The depicted work flow with system components may be utilized for synthesizing biopolymers, such as DNA chains, or for sequencing biopolymers. However, it should be understood that the present technique is not limited to sequencing operations, gene expression operations, diagnostic applications, and so forth, but may be used more generally for analyzing collected image data for multiple lines, swaths or regions detected from imaging of a sample or sample holder, as described below. Other substrates containing reaction or capture sites for molecules or other detectable features can similarly be used with the techniques and systems disclosed.

In the present context, example biopolymers may include, but are not limited to, nucleic acids, such as DNA, RNA, or analogs of DNA or RNA. Other example biopolymers may include proteins (also referred to as polypeptides), polysaccharides, or analogs thereof. Although any of a variety of biopolymers may be processed in accordance with the described techniques, to facilitate and simplify explanation the systems and methods used for processing and imaging in the example context will be described with regard to the processing of nucleic acids. In general, the described work flow will process sample holders 110, each of which may include a patterned surface of reaction sites (e.g., nanowells). As used herein, a “patterned surface” refers to a surface of a support, layer, or substrate having a population of different discrete and spaced apart reaction sites in a known pattern or geometry, such that different reaction sites can be differentiated from each other according to their relative location. A single species of biopolymer may be attached to each individual reaction site. However, multiple copies of a species of biopolymer can be attached to a reaction site. The pattern, taken as a whole, may include a plurality of different biopolymers attached at a plurality of different sites. Reaction sites can be located at different addressable locations on the same substrate. Alternatively, a patterned surface can include separate substrates each forming a different reaction site. The sites may include fragments of DNA attached at specific, known locations, or may be wells or nanowells in which a target product is to be synthesized. In some applications, the system may be designed for continuously synthesizing or sequencing molecules, such as polymeric molecules based upon common nucleotides.

In the diagrammatical representation of FIG. 2, an analysis system may include a processing system 224 (e.g., a sequencing system or station) designed to process samples provided within sample holders 110 (such as may include biological patterned surfaces), and to generate image data representative of individual sites on the patterned surface, as well as spaces between sites, and representations of fiducials provided in or on the patterned surface. A data analysis system 226 receives the image data (e.g., discrete lines of image data in a TDI imaging system context) and processes the image data in accordance with the present disclosure to extract meaningful values from the imaging data as described herein. A downstream processing/storage system 228, then, may receive this information and store the information, along with imaging data, where desired. The downstream processing/storage system 228 may further analyze the image data or processed data derived from the image data, such as to diagnose physiological conditions, compile sequencing lists, analyze gene expression, and so forth.

The processing system 224 may employ a biomolecule reagent delivery system (shown as a nucleotide delivery system 230 in the example of FIG. 2) for delivering various reagents to a sample holder 110 as processing progresses. The biomolecule reagent delivery system may correspond to the fluid delivery module or device 100 of FIG. 1. Processing system 224 may perform a plurality of operations through which sample holder 110 and corresponding samples progress. This progression can be achieved in a number of ways including, for example, physical movement of the sample holder 110 to different stations, or loading of the sample holder 110 (such as a flow cell) in a system in which the sample holder 110 is moved or an optical system is moved, or both, or the delivery of fluids is performed via valve actuation. A system may be designed for cyclic operation in which reactions are promoted with single nucleotides or with oligonucleotides, followed by flushing, imaging, and de-blocking in preparation for a subsequent cycle. In a practical system, the sample holders 110 and corresponding samples are disposed in the processing system 224 and an automated or semi-automated sequence of operations is performed for reactions, flushing, imaging, de-blocking, and so forth, in a number of successive cycles before all useful information is extracted from the test sample. Again, it should be noted that the work flow illustrated in FIG. 2 is not limiting, and the present techniques may operate on image data acquired from any suitable system employed for any application. It should be noted that while reference is made in the present disclosure to “imaging” or “image data”, in many practical systems this will entail actual optical imaging and extraction of data from electronic detection circuits (e.g., cameras or imaging electronic circuits or chips), although other detection techniques may also be employed, and the resulting electronic or digital detected data characterizing the molecules of interest should also be considered as “images” or “image data”.

In the example illustrated in FIG. 2, the nucleotide delivery system 230 provides a process stream 232 to the sample holders 110. An effluent stream 234 from the sample holders 110 (e.g., a flow cell) may be recaptured and recirculated, for example, in the nucleotide delivery system 230. In the illustrated example, the patterned surface of the flow cell may be flushed at a flush station 236 (or in many cases by flushing by actuation of appropriate valving, such as waste valve 120 of FIG. 1) to remove additional reagents and to clarify the sample within the sample holders 110 for imaging. The sample holders 110 are then imaged, such as using line imaging techniques that may be employed in conjunction with time delay and integration (TDI) processing, by an imaging system 10 (which may be within the same device). The image data thereby generated may be analyzed, for example, for determination of the sequence of a progressively building nucleotide chain, such as based upon a template. In one possible embodiment, the imaging system 10 may employ confocal line scanning to produce progressive pixilated image data that can be analyzed to locate individual sites on the patterned surface and to determine the type of nucleotide that was most recently attached or bound to each site.

As noted, the imaging components of the imaging system 10 may be more generally considered a “detection apparatus”, and any detection apparatus that is capable of high-resolution imaging of surfaces may be employed. In some examples, the detection apparatus will have sufficient resolution to distinguish features at the densities, pitches and/or feature sizes set forth herein. Examples of the detection apparatus are those that are configured to maintain an object and detector in a static relationship while obtaining an image, such as a series of line image scans in a TDI scanning process. By way of example, line scanning detectors can be configured to progressively scan a line of image data (e.g., pixels) along the y-dimension of the surface of substrate on which sample sites are disposed, where the longest dimension of the line occurs along the x-dimension. It will be understood that the detection device, object, or both can be moved relative to one another to achieve scanning detection. Detection apparatuses that are useful, for example in nucleic acid sequencing applications, are described in U.S. Pat. App. Pub. Nos. 2012/0270305 A1; 2013/0023422 A1; and 2013/0260372 A1; and U.S. Pat. Nos. 5,528,050; 5,719,391; 8,158,926 and 8,241,573, all of which are incorporated herein by reference in their entirety for all purposes.

The patterned surface undergoing scanning may include coarse-alignment markers that distinguish the relative locations of sites on the substrate surface. When used, the coarse-alignment markers can cooperate with the detection apparatus, such as to determine the location of one or more sample sites. Optionally, the relative position and/or motion of the detection apparatus and/or the sample holder 110 having the patterned surface may be adjusted based on the data obtained from imaging the coarse alignment-markers. Thus, the system may function to execute an algorithm on the computer to determine locations for the features in the image data, as well as to characterize molecules at each site, referenced based on the fiducials.

Following imaging (e.g., at imaging system 10), the sample holder 110 may progress to a deblock station 240 for de-blocking, during which a blocking molecule or protecting group is cleaved from the last added nucleotide, along with a marking dye. If the processing system 224 is used for sequencing, by way of example, image data from the imaging system 10 will be stored and forwarded to a data analysis system 226.

The data analysis system 226 may include a general purpose or application-specific programmed computer, which provides a user interface and automated or semi-automated analysis of the image data to determine which of the four common DNA nucleotides may have been last added at each of the sites on a patterned surface, as described below. As will be appreciated by those skilled in the art, such analysis may be performed based upon the color of unique tagging dyes for each of the four common DNA nucleotides. This image data may be further analyzed by the downstream processing/storage system 228, which may store data derived from the image data as described below, as well as the image data itself, where appropriate. Again, the sequencing application is intended to be one example, and other operations, such as diagnostic applications, clinical applications, gene expression experiments, and so forth may be carried out that will generate similar imaging data operated on by the present techniques.

As noted above, in some implementations, the sample holder 110 (e.g., a flow cell) having the patterned surface may remain in a fixed or substantially fixed position, and the “stations” referred to may include integrated subsystems that act on the sample holder 110 as described (e.g., for introduction and reaction with desired chemistries, flushing, imaging, image data collection, and so forth). The data analysis may be performed contemporaneously with the other processing operations (i.e., in “real time”), or may be done post-processing by accessing the image data, or data derived from the image data, from an appropriate memory (in the same system, or elsewhere). In many applications, a patterned surface “container” will comprise a cartridge or flow cell in which the patterned surface exists and through which the desired chemistry is circulated. In such applications, imaging may be done through and via the flow cell. The flow cell may be appropriately located (e.g., in the x-y plane), and moved (e.g., in x-, y-, and z-directions) as needed for imaging. Connections for the desired chemistry may be made directly to the flow cell when it is mounted in the apparatus. Moreover, depending upon the device design and the imaging technique used, the patterned surface, encased in the flow cell, may be initially located in the x-y plane, and moved in this plane during imaging, or imaging components may be moved parallel to this plane during imaging. In general, here again, the “x-y plane” is the plane of the patterned surface that supports the sites, or a plane parallel to this. The flow cell, therefore, may be said to extend in the x-y plane. It is to be understood, however, that this orientation could be reversed. The flow cell and corresponding patterned surface may also be moved in the z-direction, which is the focus-direction, typically orthogonal to both the x- and y-directions. Such movements may be useful for securing the flow cell into place, for making fluid connections to the flow cell, and for imaging (e.g., focusing the optic for imaging sites at precise z-depths). In some applications, the optic may be moved in the x-direction for precise imaging.

FIG. 3 illustrates an example data analysis system 226 and some of its functional components that may be relevant to the present approach. As noted above, the data analysis system 226 may include one or more programmed computers, with programming being stored on one or more machine readable media with code executed to carry out the processes described. Alternatively or in addition, one or more application specific integrated circuits (ASICs) and/or field programmable gate arrays (FPGAs) (or other hardware based solutions) may be employed to perform some or all of the functionality attributed to the data analysis system 226 as described herein. In the illustrated example, the data analysis system 226 includes an interface 260 designed to permit networking of the data analysis system 226 to one or more imaging systems 10 acquiring image data of patterned surfaces of reaction or sample sites (i.e., features, such as wells) within a sample holder 110. The interface 260 may receive and condition data, where appropriate. In general, however, the imaging system 10 will output digital image data representative of individual picture elements or pixels that, together, form an image of the patterned surface (or a portion (e.g., line or tile) of it). In the depicted example, a processor 262 processes the received image data in accordance with a plurality of routines defined by processing code. The processing code may be stored in various types of memory circuitry 264. As used in this disclosure, the term “machine readable” means detectable and interpretable by a machine, such as a computer, processor, or a computer or processor in cooperation with detection and signal interpretation devices or circuits (e.g., computer memory and memory access components and circuits, imaging or other detection apparatus in cooperation with image or signal interpretation and processing components and circuits), and so forth.

Computers and processors useful for the present techniques may include specialized (e.g., application-specific) circuitry and/or general-purpose computing devices, such as a processor that is part of a detection device, networked with a detection device used to obtain the data that is processed by the computer, or separate from the detection device. In some examples, information (e.g., image data) may be transmitted between components of a data analysis system 226 disclosed herein directly or via a computer network. A Local Area Network (LAN) or Wide Area Network (WAN) may be a corporate computing network, including access to the Internet, to which computers and computing devices comprising the data analysis system 226 are connected. In one example, the LAN conforms to the Transmission Control Protocol/Internet Protocol (TCP/IP) industry standard. In some instances, the information (e.g., image data) is input to a data analysis system 226 disclosed herein via an input device (e.g., disk drive, compact disk player, USB port, etc.). In some instances, the information is received by loading the information, such as from a storage device such as a disk or flash drive.

As noted above, in some examples, the processing circuitry may process image data in real or near-real time while one or more sets of image data of the support, sites, molecules, etc. are being obtained. Such real time analysis is useful for nucleic acid sequencing applications where an imaged surface having attached of nucleic acids is subjected to repeated cycles of fluidic and detection operations. Further, as discussed herein, such real-time analysis may be performed in conjunction with or as part of determining a rate of linear motion of the surface undergoing imaging, which may be of particular relevance in a line scanning implementation where TDI processing is employed. In such instances, accurate measures of linear motion may be particularly relevant for one or both of making real-time adjustments to the rate of linear motion to correspond to an expectation or tolerance established for the process and/or for informing the calculations performed as part of signal integration so that the signals associated with a given sample site can be can be integrated with a high degree of precision.

Analysis of sequencing data can often be computationally intensive such that it can be beneficial to perform the methods in real or near-real time or in the background while other data acquisition or analysis algorithms are in process. The terms “real time” and “near-real time”, when used in conjunction with the processing of samples and/or their imaging are intended to convey that the processing occurs at least in part during the time the samples are being processed and imaged (i.e., processing occurs simultaneously or contemporaneously with data acquisition). In other examples, image data may be obtained and stored for subsequent analysis by similar algorithms. This may permit other equipment (e.g., powerful processing systems) to handle the processing tasks at the same or a different physical site from where imaging is performed. This may also allow for re-processing, quality verification, and so forth.

In accordance with the presently contemplated examples, the processing code executed to process or manipulate the image data includes an image data analysis routine 270 designed to analyze the image data. Image data analysis may be used to determine the locations of individual sites visible or encoded in the image data, as well as locations in which no site is visible (i.e., where there is no site, or where no meaningful radiation was detected from an existing site). Image data analysis may also be used to determine locations of fiducials that aid in locating the sites.

As will be appreciated by those skilled in the art, in a biological patterned surface imaging context, respective sites of the patterned surface will appear brighter than non-site locations due to the presence of fluorescing dyes attached to the imaged molecules. It will be understood that the sites need not appear brighter than their surrounding area, for example, when a target for the probe at the site is not present in a sample being detected. The color at which individual sites appear may be a function of the dye employed, as well as of the wavelength range of the light used by the imaging system 28 for imaging purposes (e.g., the excitation wavelength range of light). Sites to which targets are not bound or that are otherwise devoid of a label can be identified according to other characteristics, such as their expected location on the patterned surface. Any fiducial markers may appear on one or more of the images, depending upon the design and function of the markers.

Once the image data analysis routine 270 has located individual sites in the image data, a value assignment may be carried out at step 272, often as a function of, or by reference to any fiducial markers provided. In general, the value assignment step 272 will assign a digital value to each site based upon characteristics of the image data represented by pixels at the corresponding location. That is, for example, the value assignment routine 272 may be designed to recognize that a specific color range or wavelength range of light was detected at a specific location within a threshold time after excitation, as indicated by a group or cluster of pixels at the location. The value assignment carried out at step 272 in such a context will assign the corresponding value to the entire site, alleviating the need to further process the image data itself, which will be much more voluminous (e.g., many pixels may correspond to each site) and of significantly larger numerical values (i.e., much larger number of bits to encode each pixel).

By way of further example, the present compositions, devices, and methods suitably can be used so as to generate luminescent images in sequencing-by-synthesis (SBS) techniques and devices. In such SBS approaches, a flow cell or other microfluidic device may include a sample and sample capture sites as described herein and one or more analytes may be flowed over the sites as part of a sequencing operation. A suitable number of luminophores may be employed that can be excited in sequence using any suitable number of excitation wavelengths. By way of example, four distinct excitation sources at four resonant wavelengths (λ₁, λ₂, λ₃, and λ₄) may be employed in a 4-channel SBS chemistry scheme, or two excitation wavelengths (λ₁ and λ₂) may be employed in a 2-channel SBS chemistry scheme, or one excitation wavelength (Xi) may be employed in a 1-channel SBS chemistry scheme. Examples of 4-channel, 3-channel, 2-channel or 1-channel SBS schemes are described, for example, in US Pat. App. Pub. No. 2013/0079232 A1, which is hereby incorporated herein by reference in its entirety, and can be modified for use with the apparatus and methods set forth herein. As will be appreciated, in one such SBS approach for use in sequencing DNA using luminescent imaging, a first luminophore can be coupled to A, a second luminophore can be coupled to G, a third luminophore can be coupled to C, and a fourth luminophore can be coupled to T. As another example, in techniques for use in sequencing RNA using luminescent imaging, a first luminophore can be coupled to A, a second luminophore can be coupled to G, a third luminophore can be coupled to C, and a fourth luminophore can be coupled to U.

In practice, in a multi-channel system (e.g., a four-channel system) each respective sequencing-by-synthesis (SBS) cycle has an associated separate excitation and readout operation for each channel and each channel is separately read out each cycle. That is, for each SBS cycle in a four-channel system, there are four excitation and readout operations, each corresponding to a different channel. In a DNA imaging application, for example, the four common nucleotides may be represented by separate and distinguishable colors (or more generally, wavelengths or wavelength ranges of light), each color corresponding to a separate channel that is separately readout out during each SBS cycle.

An indexing assignment routine 274 associates each of the assigned values with a location in an image index or map, which may be made by reference to known or detected locations of fiducial markers, or to any data encoded by such markers. As described more fully below, the map will correspond to the known or determined locations of individual sites within the sample holder 110. Data analysis routines (shown as data stitching step 276 in FIG. 3), which may be provided in the same or a different physical device, allows for identification or characterization of the molecules of the sample present within the sample holder 110, as well as for logical analysis of the molecular data, where desired. For sequencing, for example, the data analysis routines may permit characterization of the molecules at each site by reference to the emission spectrum (that is, whether the site is detectable in an image, indicating that a tag or other mechanism produced a detectable signal when excited by a wavelength of light). The molecules at the sites, and subsequent molecules detected at the same sites may then be assembled logically into sequences. These short sequences may then be further analyzed by the data analysis routines 276 to determine probable longer sequences in which they may occur in the sample donor subject.

It may be noted that as in the illustration of FIG. 3, an operator (OP) interface 280 may be provided, which may consist of a device-specific interface, or in some applications, to a conventional computer monitor, keyboard, mouse, and so forth to interact with the routines executed by the processor 262. The operator interface 280 may be used to control, visualize or otherwise interact with the routines as imaging data is processed, analyzed and resulting values are indexed and processed.

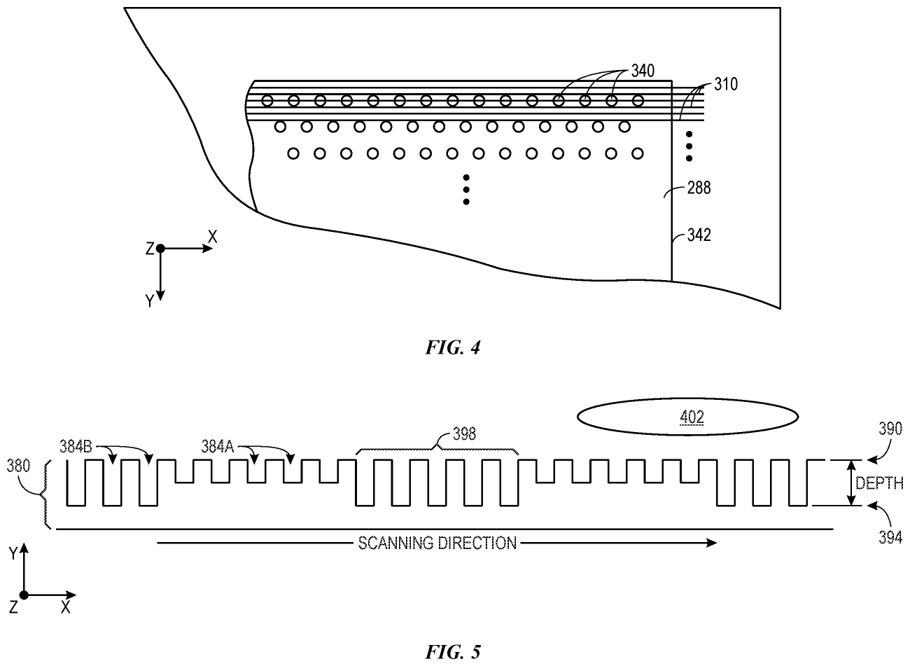

FIG. 4 illustrates, by way of example, scan lines 310 over a plurality of sample sites 340 (e.g., wells or nanowells) provided on a patterned surface 288. By way of example, in the context of a flow cell the sites 340 may be gel-filled wells, each well occupied by a nucleic acid (e.g., DNA) colony. As noted above, in some implementations, the sites 340 may be laid out in any suitable pattern. In the illustrated example, the sites 340 are laid out in a hexagonal pattern, although rectangular patterns (e.g., rectilinear patterns), and other patterns may be employed. The location of each site 340 will be known with reference to one or more fiducial or reference features, such as an edge 342 of the grid or portion of the patterned surface 288.

With the preceding background and context in mind, certain embodiments discussed herein utilize features on a sample layer or substrate (e.g., a patterned surface of a flow cell) itself to control, adjust, and/or calibrate motion feedback during a scan operation. By way of example, nanoscale features of the sample substrate, such as wells or sites on or in which sample is disposed or lithographically patterned features formed as part of a layer of the flow cell, may be used as part of the feedback mechanism. In certain such implementations, a nanopatterned periodic set of features may be provided as part of the sample substrate and may be used to facilitate the motion feedback calculations and/or operations.

In one embodiment, and as described below, differential depths or diameters of the nanowells 384 (e.g., shallow nanowells 384A and deep nanowells 384B) may be leveraged to provide or derive data regarding relative linear translation velocity of the flow cell 380 in the scanning direction during a scan operation. In particular, an emissive component, such as an IR or NIR emitter (e.g., a NIR superluminescent diode) provided as part of the focusing assembly (e.g., focusing emitter 150 and focusing detector 141) may be employed in a continuous or intermittent (e.g., periodic or non-periodically intermittent) mode of operation to obtain measurements (such as via focusing detector 141) as the flow cell is linearly translated during a scanning operation. As may be appreciated, in implementations employing the focus tracking system, such as a focusing emission and detection assembly the location of the reflected spot(s) at a respective sample site (or other focus tracking location) is tracked as the stage undergoes relative motion as part of scanning the sample(s).

In other embodiments, regions of reflective or fluorescent material may be formed on a layer of the flow cell, such as the bottom surface of a layer (e.g., a functional layer) opposite the nanowell array on the same layer. Alternatively, the regions of reflective or fluorescent material may be formed on a separate layer (e.g., a substrate layer) separate and distinct from the layer (e.g., the functional layer) on which the nanowells are formed and/or the reflective or fluorescent material may be formed as a separate layer distinct from the functional and substrate layers. The reflective or fluorescent material, wherever deposited or formed, may be lithographically patterned to form features that can be observed during (i.e., concurrent with) a scan operation, such as using an IR or NIR emitter (e.g., a NIR superluminescent diode) provided as part of the focusing assembly (e.g., focusing emitter 150 and focusing detector 141. The measurements thereby obtained may be used to derive a linear translation velocity and/or other position or motion measures of interest, such as position in the scanning direction, drift in the cross-sample direction, rotation and/or skew, and so forth.

By way of further example, the periodically spaced apart features or regions of features (either nanowells having different geometric parameters (e.g., alternated regions of shallow and deep nanowells) or lithographically patterned features) modulate emitted wavelengths different than those employed by the imaging sub-system. By way of example, in certain implementations the periodically spaced apart features or regions of features modulate near infrared (NIR) reflectivity (or otherwise generate a modulated intensity signal), such as in response to NIR emissions from one or more emitters that are provided as part of the focusing sub-system of a sequencing imager. By way of example, in one implementation the nanowells may be formed so as to have different depths (e.g., a first depth and a second depth; a first depth, a second depth, and a third depth; and so forth) at periodic or otherwise known intervals on a layer of the flow cell along a scanning direction corresponding to a direction of relative motion that the flow cell undergoes during a scanning operation. The different nanowell depths are observable as changes or variations in reflectivity of a beam (e.g., an IR or NIR beam) directed at the surface as the surface is linearly translated. By way of example, when exposed to a focusing emitter 150 the different nanowell depths may be observed as different measured intensities at the focusing detector 141. The observed nanowell depth-based modulation, in accordance with this approach, may be provided as or used to derive feedback for the actuators controlling motion of stage 170 and/or optic motion mechanisms of the imager system 10 in the scanning direction so as to adjust, calibrate, or otherwise control relative motion (e.g., linear motion velocity) of the flow cell during a scan operation. In addition or in the alternative, the relative linear motion (e.g., velocity) derived from the measured signal intensity modulation may be provided to a controller or computational component e.g., processor) performing signal integration so as to facilitate aggregating or integrating signals associated with respective sites properly in a TDI context.

An example of such an arrangement is depicted in FIG. 5 as a sectional view taken along a portion of a flow cell 380. In the depicted example, nanowells 384 formed in a functional layer of the flow cell 380 vary in depth along a scanning direction in which the flow cell 380 moves relative to the optics during a scan operation. In the depicted example, the nanowells 384 vary between two relative depths in accordance with a periodic pattern (e.g., 5 shallow, 5 deep, 5 shallow, . . . ) along the scanning direction. However, in other embodiments the number of shallow nanowells 384A relative to deep nanowells 384B may not be equal (e.g., 3 shallow, 4 deep, 3 shallow, . . . ) or may otherwise vary. Further in still other embodiments the nanowells 384 may be formed so as to have more than two relative depths, such as to have three relative depths (e.g., shallow, mid, and deep), four relative depths (e.g., shallow, shallow-mid, deep-mid, and deep), and so forth. As shown in the sectional view of FIG. 5, the relative depths of the respective flow cell 380 may be defined with respect to a top surface 390 and a bottom surface 394 of the functional layer of the flow cell 380, with the relative depths being conventionally measured from the top surface 390 in the depicted example of an embodiment. In practice, a difference in nanowell depths of as little 10% may be resolvable in the manner described herein. That is, there may be as little as a 10% difference in the depth of shallow and deep nanowells as described herein while still being able to discern and utilize the observed signal modulation. While variation in the depths of nanowells 384 is provided herein by way of example and to facilitate explanation by providing a specific context, in practice other geometric parameters (e.g., shape, diameter, radius, perimeter, circumference, longest axis, shortest axis, and so forth) of the nanowells 384 may be varied in addition to or instead of depth. By way of example, the diameter of the nanowells may be varied instead of or in addition to the depths to provide a modulated signal intensity. In one such example, the nanowells 384 may differ in depth and diameter in a known or designed manner such that the aspect ratio of all nanowells 384 remains the same while allowing for the reflectivity variations described herein that modulate intensity of the focus sub-system emissions so as to allow estimation and/or tracking of linear translation speed of the flow cell.

As noted above, the differential depths (and/or diameters) of the nanowells 384 in such a context results in differential or otherwise modulated measurements that when processed may, over a window of time, correspond to or approximate a function or plot (e.g., an approximation of a sinusoidal signal) that when observed over the time window, and with knowledge of the pattern of the relative depths, spacing, and underlying pattern of the nanowells 384, can be used to measure the linear translation velocity of the flow cell 380 over time in the scanning direction. In practice, generation of a sinusoidal signal may be facilitated by having a focus beam diameter greater than the period associated with the differentially reflective features. By way of example, in one implementation, the period or periodic interval 398 associated with a set of features (e.g., nanowells 384) of a given depth may be less than the diameter 402 of a respective scanning focus beam in a TDI system. For example, the period 398 may be 7μ relative to a beam diameter 402 of 10μ to obtain a sinusoidal signal that may be used to determine linear translation velocity. Indeed, in such a TDI context, if the period of intensity variations is less than (or equal to) the integration width a suitable sinusoidal signal may be derived.

In practice, such linear velocity measurements employing the focusing sub-system may be interleaved with the focusing operations and measurements for which the focusing sub-system is primarily used as part of a scanning operation. Alternatively, a separate emissive component (e.g., an IR or NIR emitter(s) and corresponding detector components) may be provided that is dedicated to linear motion monitoring if such a dedicated and separate sub-system is determined to be appropriate. As will be appreciated, and with reference to FIG. 5, in the context of a front-lit focusing assembly, the emissive component for linear motion measurement may reflect from the bottoms of the nanowells 384, which are of varying depths, or may reflect from the bottom surface 394 of the glass flow cell substrate, with the differential path length beneath the nanowells 384 to the bottom layer 394 effectively providing the varying depth information over time. In addition, and as further noted herein, the present approach to obtaining measurements from which linear motion may be derived does not require sample fluorescence within the nanowells 384, and thus may be performed prior to or during sequence cluster development, unlike current conventional approaches.

As discussed herein, to generate feedback regarding the relative speed of the scanning stage on which the flow cell is positioned, the image scanner (such as using controller(s) 190 or other processing components) may execute routines or code to decode the measured intensity fluctuations at the tracked locations that correspond to modulation attributable to nanowell depth (or diameter) variation. In one example, the measured intensity fluctuations attributable to nanowell depth differences may be isolated from other sources of intensity fluctuations using digital signal processing (DSP) techniques including, but not limited to, Fast Fourier Transform (FFT) based filtering of frequencies. Such techniques may be used to filter and/or otherwise isolate frequencies consistent with the linear motion of a periodically varying set of nanowells being translated on a stage 170 moving at an expected velocity, as described herein, from other frequencies that would not be expected to be associated with such stage motion. In addition, in systems employing more than one (e.g., two, three, four, or more) focus spots, cross-correlation of the intensity of the different spots can be used to amplify intensity changes that affect the two or more spots simultaneously, thus improving the measured signal or signal-to-noise ratio. More particularly, two or more focus beams may allow for independent processing and verification so as to better identify actual alignment or speed deviation issues relative to intermittent fluctuations.

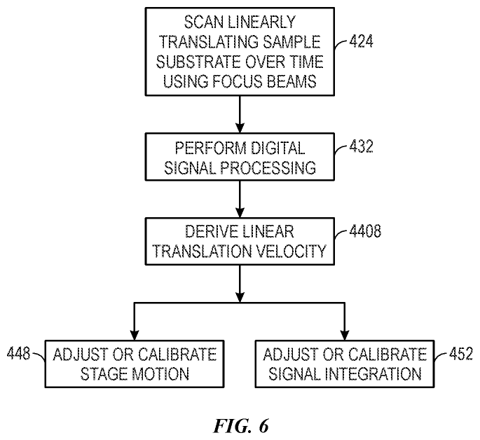

With the preceding in mind, and by way of providing an example of a process flow of one implementation, FIG. 6 depicts process steps in accordance with the present discussion and examples. As shown in FIG. 6, a sample substrate with periodically varying features (e.g., nanowells of two different depths, diameters, and so forth, lithographically patterned features, and so forth) may be interrogated (step 424) while being linearly translated during a scan operation. As discussed herein, such interrogation may be performed by scanning using one or more NIR focusing emitters 150 that are additionally used to derive focus measurements for the substrate 420. Modulated intensity data (e.g., reflectivity data) is generated in response to scanning the substrate 420 using the one or more focus beams and, in certain implementations, the modulated intensity data may undergo digital signal processing (step 432) so as to generate a set of filtered intensity data in which frequencies not associated with the linear motion of the stage 170 have been removed. In the depicted example, the filtered intensity data may be used to derive (step 440) a linear translation velocity of the sample substrate as it undergoes scanning. By way of example, the filtered intensity data may be, or may be used to derive, a sinusoidal signal having a period from which the linear translation velocity may be calculated. In the depicted process flow, the linear translation velocity may be provided to a controller 190 or other processing component to adjust or calibrate the motion of the sample stage 170 (step 448) in real-time or near real-time and/or to adjust of calibrate a signal integration operation (step 452) performed as part of a time delay and integration technique.

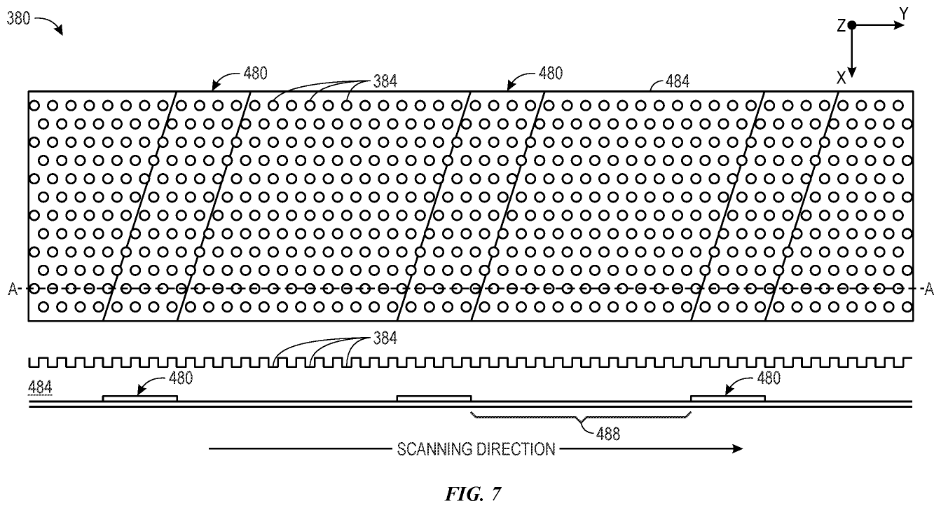

The preceding provides one example of an approach by which features provided on a sample substrate may be used in conjunction with existing imager components (e.g., a focus tracking subsystem and its constituent emitters and detectors) to perform real-time velocity assessment and correction. However, it may be appreciated that other implementations of such techniques may be employed that provide the benefits described herein. By way of example, and turning to FIG. 7, in accordance with certain embodiments the reflectivity of an incident focus beam having a wavelength λ can be modulated using a thin film or coating formed on or applied to the sample substrate 110 (e.g., a flow cell 380) and having a disparate refractive index (n). In one such example, the thickness of the reflective film or layer may be less than V n. In an example implementation, the reflective film or layer may be comprised of a material (e.g., a dielectric material or metal film) with a refractive index different than the glass substrate or nanoimprint lithography (NIL) resin (e.g., TaOₓ).

The reflectivity of the incident beam may be modulated (such as due to different thicknesses or heights of the film or layer at different locations) at the interface between the thin film and the substrate (e.g., glass substrate) on which the film is disposed. That is, the film or layer can include periodic regions of thicker or thinner features than the nominal area thickness. In one embodiment utilizing components of the focus tracking module, a scaled pattern associated with the disparate refractive index may be designed or configured to modulate signal intensity, such as using destructive interference patterns selected to interact with the focus illumination wavelength.

As shown in FIG. 7, a plan view is shown as the top-view. A view line A-A is depicted in the plan view along which a sectional view (shown below) is taken. In such an example, the reflectivity of an incident beam (such as from a focusing emitter 150 in certain implementations) at an interface between two materials (e.g., the interface between a functional layer 484 of the flow cell 380 and a reflectivity modulation layer or structures 480 formed on or applied to the functional layer 484) can be used to generate a measured reflectance signal that may be processed as discussed herein to derive information about the motion, position, and or orientation or rotation of the sample substrate over time.

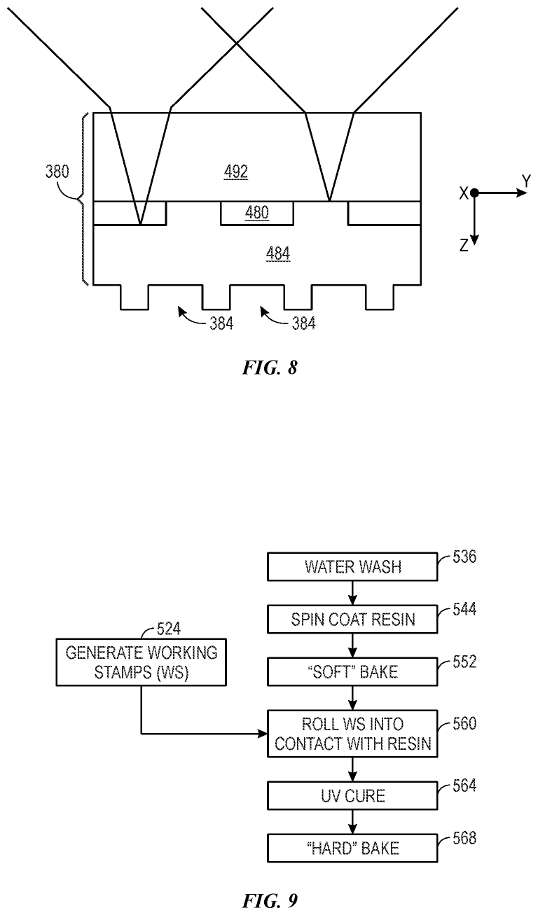

In the certain embodiments, the thin film modulation layer, provided as reflective structure or layer 480, may exhibit a disparate refractive index n at the interface due to the layer 480 being deposited or applied at two or more different thicknesses (e.g., a first thickness of the reflective material 480 and a second thickness of the reflective material 480) at periodic or known intervals, as shown in the sectional view. In practice, and as shown in FIG. 8 (discussed in greater detail below) one of the respective thicknesses may be zero or substantially zero thickness such that the reflective material of the modulation layer 480 is only effectively present in isolated regions or zones, with substantially no reflective material spanning or connecting these regions. Alternatively, and as shown in FIG. 7, in other embodiments the thickness of the film may vary from a first non-zero thickness to a second non-zero thickness such that the modulation of the reflected light or energy is a function of the changes in thickness in the modulation layer 480 The thickness of the reflective material 480 may be selected or engineered to minimize the reflectivity of the incident focus beam by eliminating destructive interference of the reflected wavefront or to, conversely, maximize the reflectivity by promoting destructive interference of the reflected wavefront. By periodically modulating the thickness of the reflective material 480, the reflectivity of the focus beam is correspondingly modulated. The period or periodic interval 488 of thickness modulation can be tuned to achieve a near sinusoidal or digital reflected signal. In certain embodiments, the reflective material 480 may be coated with a thin layer of a high-index dielectric or thin metal (e.g., a metal film) to form an external or bottom surface or layer. While reflectivity is used by way of example, it should be understood that in alternative implementations the signal modulation material may, instead of or in addition to being reflective, may be fabricated using a resin or other material that fluoresces at the wavelength of the interrogation beam (i.e., in response to the wavelength of a NIR focus beam) and that the measure fluorescent signal is instead measured and processed to derive a linear translation velocity. It should be appreciated that, in such embodiments the excitation frequency and fluorescence wavelength may be selected to as to differ from, and be discernible from, and excitation and/or fluorescence that may be associated with sample measurements performed using the flow cell 380.

With reference to FIG. 8, an additional view of the respective layers of such an embodiment is provided. In this example, a functional layer 484 of a flow cell 380 is depicted in which nanowells 384 are formed. As shown, the flow cell 380 also includes a substrate layer 492, such as a glass substrate layer, on which the functional layer 484 is formed or otherwise fabricated proximate to. As shown in FIG. 8, reflective material 480 may be formed or deposited on a surface of the functional layer 484 opposite the nanowells 384. In practice, however, it may be appreciated that the reflective material 480 may be formed or deposited on a top or bottom surface of the substrate layer 492 (as opposed to the functional layer 484) and/or may be formed or deposited as a separate layer from either the functional layer 484 or substrate layer 492. In addition, as shown in FIG. 8, beams from a focus emitter are shown interrogating the flow cell and differentially penetrating the flow cell 380, allowing a modulated signal to be observed that may be used as described herein to evaluate linear motion of the flow cell 380.

As may be appreciated, fabrication of structures as shown in FIGS. 7 and 8 and as discussed elsewhere herein may be accomplished using lithographic techniques or other suitable techniques for manufacturing structures having nanoscale features and/or coatings. By way of example, fabrication of such a structure may involve deposition of an initial thin film of reflective material 480 on the functional layer 484 or substrate layer 492. The deposited thin film 480 may then be patterned using suitable patterning techniques.

An example of one such technique may include, but is not limited to, nanoimprint lithography (NIL). In such an example, a resin selected or designed to have a specifically engineered refractive index that is different than the layer or substrate (e.g., functional layer 484 or substrate layer 492) in which the patterned structures are to be formed is used to form a thin film (such as of reflective material 480) on the underlying layer. By way of example, a resin may be deposited and patterned on a surface of the functional layer 484 opposite the surface in which the nanowells 384 are formed. By way of example, following the nanopatterning of the reflective material 480, the array of nanowells 384 may be formed in the functional layer 484 on the opposite surface relative to the reflective material 480 using conventional workflows. In certain embodiments, some degree of coarse alignment between the array of nanowells 384 and the patterning of the reflective material 480 may be performed.

By way of further explanation, an example of one implementation of a NIL workflow suitable for forming a patterned resin on a substrate is illustrated in the depicted process flow of FIG. 9. In this example, a master template is used to generate (step 524) one or more working stamps (WS). Separately, a glass wafer may be initially prepared for the coating and lithography process, such as by washing (step 536) (e.g., a megasonic water wash) the glass wafer with water. The glass wafer may then be spin coated (step 544 with a resin (e.g., an ultraviolet (UV) curable resin) so as to coat one surface of the glass wafer with the resin. In one implementation, a first (e.g., “soft”) bake operation may then be performed, such as a 130° C., to generate a wafer that is coated on one side or surface.

The resin layer (e.g., reflective material 480) of the coated wafer may then be imprinted using a working stamp to form a pattern, such as a pattern of relatively thin and thick regions of the layer (e.g., a first thickness of the reflective material 480 and a second thickness of the reflective material 480). As previously noted, in certain embodiments the thin regions of reflective material 480 may be essentially zero thickness such that separate and distinct regions of reflective material 480 (i.e., the thick regions) are formed without being interconnected by other portions of reflective material 480. By way of example, a working stamp may be rolled (step 560) into contact with the resin layer so as to form the pattern of differential thickness within the resin layer. In the depicted example, the coated wafer may then undergo a UV cure step 564. A second (e.g., “hard”) bake operation may then be performed, such as a 200° C., to generate a wafer having a patterned, resin-layer on one side or surface. As noted above, the patterned, resin-coated wafer may then be further processed so as to form an array of nanowells 384 on the opposite surface.

While an NIL process as described herein may be one suitable process for generating regions of reflective material 480 on a sample substrate, in practice other suitable patterning techniques may be employed. By way of example, other suitable patterning techniques include, but are not limited to, lithographic patterning via etching or lift off.

Turning back to FIGS. 7 and 8, the reflective material 480 having regions of differing thickness may be employed in a similar manner to the nanowells of differing depth and/or diameter to allow measurement of linear translation velocity in real-time or near real-time during a scan operation using conventionally present emitting devices, such as the focusing emitter(s) 150 and focusing detector(s) 141. In particular, the change in reflectance observed by the focusing emitter with respect to the layer 480 sampled and processed as shown with respect to FIG. 6 may be used to derive a linear translation velocity 444 that may in turn be used to adjust or calibrate stage motion during a TDI scan operation and/or to adjust or calibrate signal integration in a TDI scan operation.

While FIGS. 7 and 8 depict examples of a patterned modulation layer formed using the reflective material 480 on a layer or substrate suitable for measuring linear translation velocity as described herein, other examples are provided and described below. As discussed with respect to certain examples, the reflective (or fluorescent) features imprinted or otherwise formed on the layers of the flow cell 380 may be provided in various patterns, certain of which may provide additional or alternative information. By way of example, a useful pattern of features may be one that has features configured or designed to generate feedback related to the drift of the sample in the x-dimension and/or other features designed to generate feedback related to the sample speed (i.e., linear translation) or position in the y-dimension. In certain embodiments, the pattern of features may also provide useful skew or rotation information related to the placement or movement of the sample substrate during a scan operation.

With respect to certain such implementations, if the reflective patterned features are interrogated with a light source (e.g., focusing emitter(s) 150) that does not excite fluorescence from DNA clusters present in the nanowells 384, the resulting reflected light may be used to infer stage drift in the x-dimension as well as stage speed (i.e., linear translation velocity) in the y-dimension concurrently. Furthermore, if the distance between the reflective features in the x- and y-dimensions is smaller than the interrogation illumination footprint, a reflected signal that has a sinusoidal trend in intensity would be detected which could be used to accurately interpolate y-dimension stage speed and position even in the intervals between the features.

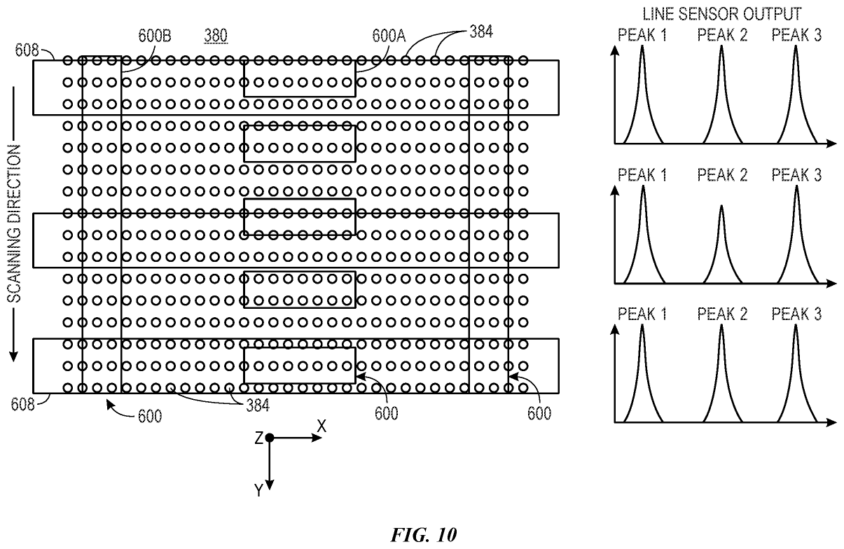

By way of example, and turning to FIG. 10, a plan view of a flow cell 380 having an array of nanowells 384 is depicted. In addition, differentially reflective features 600, such as may be formed by lithographic patterning of a reflective material 480 as discussed elsewhere herein, are illustrated in accordance with an example placement for one embodiment. As discussed herein, the reflective material 480 and differentially reflective features 600 patterned from the reflective material 480 may be formed on a surface of the flow cell 380 opposite the surface in which the nanowells 384 are formed or, alternatively, on another layer forming the flow cell 380.

In the depicted example two sets of reflective features 600 are depicted, a first set of reflective features 600A that are periodically spaced apart in the scanning direction (i.e., the y-dimension) and a second set of periodic features 600B spaced apart in the cross-sample dimension (i.e., the x-dimension). As discussed herein, each respective set of reflective features may provide different information and/or the combination of the information derived from each set of features may provide information not readily ascertainable from a single set of features alone. For example, the first set of features 600A may be useful for deriving information about placement and/or velocity in the y-dimension while the second set of features 600B may be useful for deriving information about placement and/or linear drift in the x-dimension. By way of further example, the information derived from both the first set of features and the second set of features may be useful for deriving information about rotation or skew that may not be easily ascertainable from a single set of the features.

In one implementation the reflective features 600 may reflect interrogating radiation (e.g., NIR from focusing emitter(s) 150) which can then be detected. By way of example, in one implementation one or more NIR emissions may be intrinsically line shaped or otherwise shaped into a line so as to linearly interrogate the reflective features 600 using a line sensor. By way of example, FIG. 10 depicts concurrent single NIR emission lines 608 imaged to a line sensor. In the depicted example, the width of the NIR emission line 608 in the scanning direction (i.e., y-dimension) is greater than the distance between the reflective features 600A periodically positioned in the scanning direction. Based on this, an intensity signal, as illustrated by Peak 2 in the accompanying line sensor output measures, may be determined. In particular, as shown in the accompanying line sensor outputs, the top and bottom line sensor outputs correspond to readouts in which the corresponding reflective features 600A are fully within the corresponding NIR emission lines 608, thus generating a full signal as shown in the corresponding output graphs at Peak 2. Conversely, for the middle line sensor output, corresponding to a readout in which the reflective feature 600A is not fully within the corresponding NIR emission line 608, the output graph at Peak 2 is less than the Peak 2 measures in the top and bottom graphs, corresponding to the partial or otherwise limited presence of the respective reflective feature 600 within the corresponding NIR emission line. Thus, the Peak 2 line sensor outputs in the context of this example, will vary within a range between a maximum and a minimum as the sample substrate is scanned while moved in the scanning direction, thereby effectively generating a sinusoidal intensity signal that may be used to derive a linear velocity, as discussed herein.

Further, while Peak 2 in the depicted example (corresponding to the observed signal intensity of the reflective features 600A) may be used to assess velocity of motion in the scanning direction, Peaks 1 and 3 may be used to assess drift in the x-dimension (i.e., the cross-sample direction). In particular, in the depicted example Peaks 1 and 3 correspond to the observed signal intensity of the two reflective features 600B, which are spaced a fixed distance apart from one another, but which do not, in the depicted example, vary periodically in either the x- or y-dimensions. However, in accordance with certain implementations, a shift to the left or the right of Peaks 1 and 3 over time is indicative of a drift in the x-dimension of the flow cell 380. With this in mind, the depicted example may be used to simultaneously assess linear velocity in the scanning direction using Peak 2 and drift in the cross-sample direction using Peaks 1 and 3. It may also be appreciated that, while the reflective features 600B in the depicted example are depicted as continuously linear, in practice they may include periodic breaks (i.e., be “dashed”) while providing the same information as described here.

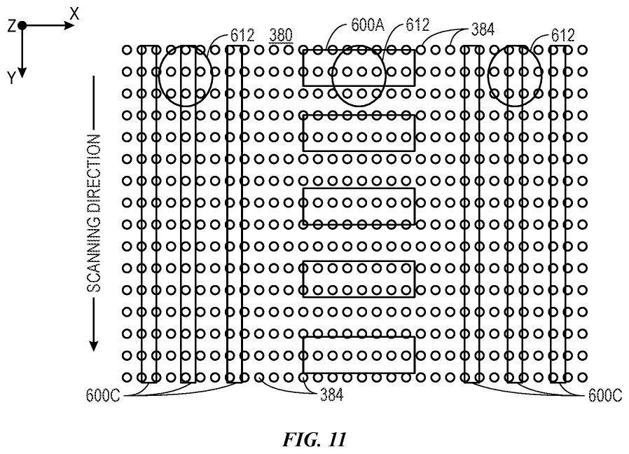

In a further example, and turning to FIG. 11, reflective features 600 may be employed for use in monitoring cross-sample drift that also provide a modulated response, such as a sinusoidal signal intensity. In the depicted example, a plan view of a flow cell 380 having an array of nanowells 384 is again depicted. Similar to other examples, differentially reflective features 600, such as may be formed by lithographic patterning of a reflective material 480 as discussed elsewhere herein, are illustrated in accordance with an example placement. As discussed herein, the reflective material 480 and differentially reflective features 600 patterned using the reflective material 480 may be formed on a surface of the functional layer 484 opposite the surface in which the nanowells 384 are formed or, alternatively, on or as another discrete layer forming the flow cell 380.

As in the preceding example, a first set of reflective features 600A are depicted that are periodically spaced apart in the scanning direction (i.e., the y-dimension). In the example of FIG. 11 a second set of periodic features 600C are depicted that are spaced apart in the cross-sample dimension (i.e., the x-dimension). As described herein, each respective set of reflective features may provide different information and/or the combination of the information derived from each set of features may provide information not readily ascertainable from a single set of features alone.

In the depicted example of FIG. 11, the interrogating radiation (e.g., NIR from focusing emitter(s) 150) may be concurrently incident on the surface of the flow cell 380 at separate locations in the cross-sample direction (i.e., x-dimension), though there may be additional beams in the scanning direction as well which are not presently shown. In this example, the incident beams 612 have a circular or spot footprint on the surface of the flow cell 380. In the depicted example, the diameter of the NIR emission spots 612 in the scanning direction (i.e., y-dimension) is greater than the distance between the reflective features 600A periodically positioned in the scanning direction. Based on this, as previously noted, a sinusoidal intensity signal related to the speed of the stage in the scanning direction may be derived. That is, the measured signal intensity corresponding to the reflective features 600A will vary within a range between a maximum and a minimum as the sample substrate is scanned while moved in the scanning direction, thereby effectively generating a sinusoidal intensity signal that may be used to derive a linear velocity, as discussed herein.

With respect to the reflective features 600C, in the depicted example, the reflective features 600C to the right and left of the reflective features 600A form respective linear groupings running in the scanning direction and that are spaced apart from one another in the cross-sample direction at a known distance as well as being spaced apart in the cross-sample direction within their respective groupings. That is, in the depicted example, one grouping of three linear reflective features 600C run in the scanning direction to the left of the reflective features 600A while a second grouping of three linear reflective features 600C run in the scanning direction to the right of the reflective features 600A.

In one implementation a respective NIR emission spot may be associated with each of the reflective features 600A, the left grouping of reflective features 600C, and the right grouping of linear features 600C. As with the reflective features 600A, the respective groupings of reflective features 600C may generate sinusoidal signals in the event of drift in the x-dimension due to the diameter of the NIR spots 612 exceeding the spacing between the respective reflective features 600C within each respective grouping. With this in mind, in the depicted example linear velocity in the scanning direction may be simultaneously monitored with motion or drift in the cross-sample direction.

As will be appreciated in this example and the related examples below, the reflective features 600C may serve the function of an x-dimension encoder, thereby allowing measurement or estimation of motion in the x-dimension and/or drift over time in the x-dimension. Such measures or estimates with respect to cross-sample motion or drift may be used to perform or improve an image registration process, an image correction process, and/or generation of application of a shift or transformation mapping process. Correspondingly, such approaches may allow for the use of less expensive or precise stage controls and/or for greater motion tolerance in the cross-sample dimension.

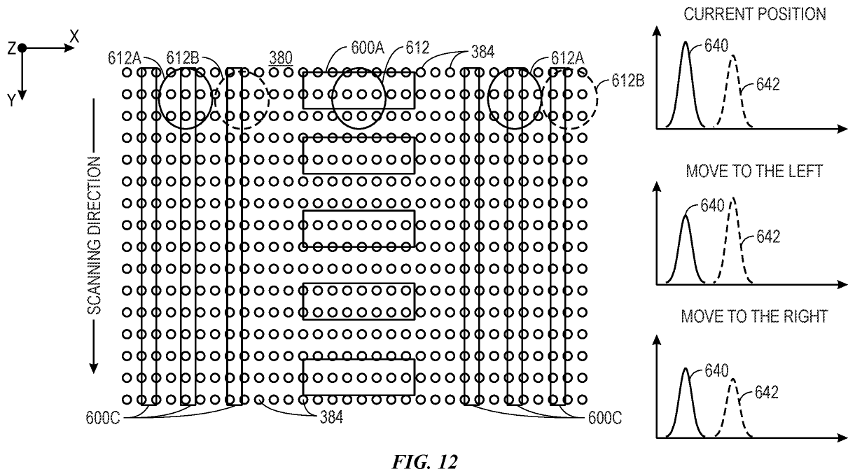

In a further example, and turning to FIG. 12, a further implementation is depicted in which reflective features 600 may be employed for use in monitoring cross-sample drift and that also provide a modulated response, such as a sinusoidal signal intensity. In the depicted example, a plan view of a flow cell 380 having an array of nanowells 384 is again depicted. Similar to other examples discussed herein, differentially reflective features 600, such as may be formed by lithographic patterning of a reflective material 480 as discussed elsewhere herein, are illustrated in accordance with an example placement. As discussed herein, the reflective material 480 and differentially reflective features 600 patterned using the reflective material 480 may be formed on a surface of the functional layer 484 opposite the surface in which the nanowells 384 are formed or on or as another discrete layer of the flow cell 380.

As in the preceding example, a first set of reflective features 600A are depicted that are periodically spaced apart in the scanning direction (i.e., the y-dimension). As in the preceding example, a second set of periodic features 600C are depicted that are spaced apart in the cross-sample dimension (i.e., the x-dimension). As described herein, each respective set of reflective features may provide different information and/or the combination of the information derived from each set of features may provide information not readily ascertainable from a single set of features alone.

In the depicted example of FIG. 12, the interrogating radiation (e.g., NIR from focusing emitter(s) 150) may be concurrently incident on the surface of the flow cell 380 at separate locations in the cross-sample direction (i.e., x-dimension), though there may be additional beams in the scanning direction as well which are not presently shown. In this example, the incident beams 612 have a circular or spot footprint on the surface of the flow cell 380. In the depicted example, the diameter of the NIR emission spots 612 in the scanning direction (i.e., y-dimension) is greater than the distance between the reflective features 600A periodically positioned in the scanning direction. Based on this, as previously noted, a sinusoidal intensity signal related to the speed of the stage in the scanning direction may be derived. That is, the measured signal intensity corresponding to the reflective features 600A will vary within a range between a maximum and a minimum as the sample substrate is scanned while moved in the scanning direction, thereby effectively generating a sinusoidal intensity signal that may be used to derive a linear velocity, as discussed herein.

With respect to the reflective features 600C, as described in the preceding example the reflective features 600C to the right and left of the reflective features 600A form respective linear groupings running in the scanning direction and that are spaced apart from one another in the cross-sample direction at a known distance as well as being spaced apart in the cross-sample direction within their respective groupings. That is, in the depicted example, one grouping of three linear reflective features 600C run in the scanning direction to the left of the reflective features 600A while a second grouping of three linear reflective features 600C run in the scanning direction to the right of the reflective features 600A.

In one implementation respective NIR emission spots may be associated with each of the reflective features 600A, the left grouping of reflective features 600C, and the right grouping of linear features 600C. As with the reflective features 600A, the respective groupings of reflective features 600C may generate sinusoidal signals in the event of drift in the x-dimension due to the diameter of the NIR spots 612 exceeding the spacing between the respective reflective features 600C within each respective grouping. With this in mind, in the depicted example linear velocity in the scanning direction may be simultaneously monitored with drift in the cross-sample direction.

In the depicted example, each grouping of reflective features 600C is shown as being interrogated by two respective incident beams offset in the x-dimension. In the depicted example, this may be implemented as a first incident beam 612A that is centered on one linear feature of each grouping (here depicted as the centermost feature) and a second, offset incident beam 612B offset from the first incident beam so as not to be centered on a feature of the respective grouping of linear features when the first incident beam is centered on its respective feature. This is depicted in FIG. 12 via a series of plots illustrating the measured signal that may be observed with respect to the respective incident beams 612A and 612B in the event of various motions in the cross-sample dimension (i.e., x-dimension). By way of example, and with reference to the top-most plot, a first curve 640 (leftmost) is indicative of the signal generated in response to the first incident bean 612A when generally centered on a corresponding reflective feature 600C. Due to the second incident beam 612B not being centered on its corresponding reflective feature 600C when the first incident beam 612B is centered, the second plot 642 is indicative of a weaker relative measured signal (i.e., lower peak) in this scenario.

As shown in the subsequent plots however, in the event of motion in the cross-sample dimension which centers the incident beam 612B over its corresponding reflective feature 600C (i.e., motion to the left, shown in the middle plot), this situation may be altered or even reversed. By way of example, the middle plot of FIG. 12 illustrates a scenario in which the incident beam 612B is centered on its respective reflective feature 600C (i.e., high signal) while the incident beam 612A is no longer centered on the centermost reflective feature, thereby generating some value less than the signal observed for the incident beam 612B. This scenario is illustrated in the middle plot in which the first curve plot 640 (leftmost) indicative of the signal generated in response to the first incident beam 612A is seen to have a lower amplitude than the second curve plot 642 (rightmost) indicative of the signal generated in response to the second incident bean 612B due to leftward cross-sample motion.

Similarly, in the event of rightward cross-sample motion, neither of the incident beams 612A or 612B may be well-centered over respective linear reflective features 600C. Correspondingly, neither incident beam 612 produces a maximal signal. This scenario is illustrated in the bottom-most plot in which the first curve plot 640 (leftmost) indicative of the signal generated in response to the first incident beam 612A and the second curve plot 642 (rightmost) indicative of the signal generated in response to the second incident bean 612B are both seen as being lower than their peak values due to being off-center with respect to illuminated reflective features 600C. With this context and these examples in mind, the respective relative amplitudes of the first curve plot 640 and the second curve plot 642 may be measured over time and used to identify regular or periodic motion in the cross-sample direction (i.e., x-dimension). More generally, even in the absence of periodic or repeated motion in the cross-sample dimension observation of the relative heights of the first curve plot 640 and the second curve plot 642 may be used to obtain location and/or motion information for the flow cell 380 in the cross-sample dimension during a scan operation. Such relative comparison of peak heights for determination of location or motion in the cross-sample dimension may leverage knowledge of the relative spacing of the reflective features 600C and of the respective offset of incident beams 612A and 612B from one another so that peaks and valleys in measured reflectance can be related to the known physical layout of the reflective features 600C and the physical geometry and offset of the incident beams 612A and 61B.

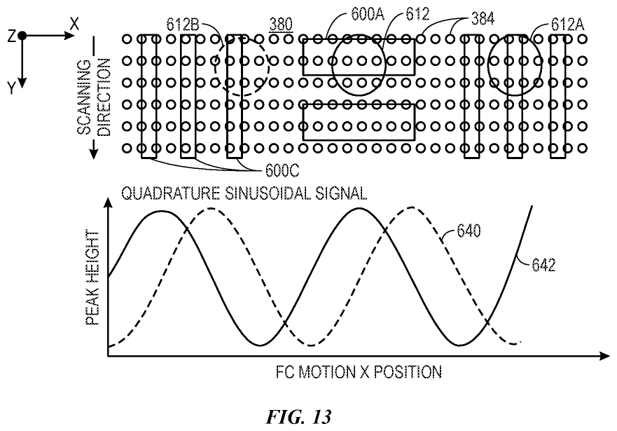

A further variation on the implementation shown in FIG. 12 is illustrated in FIG. 13. In this example, the number of incident beams 612 is reduced relative to the embodiment shown in FIG. 12. By way of example, and with respect to the linear reflective features 600C, a single incident beam 612A is illustrated on one side (here depicted on the right) of the central reflective features 600A so as to be centered on the central reflective feature 600C on that side. Conversely, on the other side (here depicted as the left) of the central reflective features 600A, an incident beam 612B is offset with respect to the incident beam 612A so as to be generally positioned, but not centered, with respect to the other set of reflective features 600C. The measured values obtained by reflection of both incident beam 612A and the incident beam 612B will vary as drift or motion occurs in the cross-sample dimension, as previously described, allowing motion and/or location in the x-dimension to be measured or estimated over time. In this manner, what may be expected to be redundant measures or information may be removed so as to simplify the system and measurements. The measured reflectance values associated with the incident beam 612A and the incident beam 612B may be tracked or mapped to a quadrature sinusoidal signal, shown in the accompanying graph, that associated flow cell motion x-position with measurement peak height for each of incident beam 612A and incident beam 612B such that a measurement at a given point in time may be associated with flow cell motion in the x-dimension.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A patterned flow cell, comprising:
a functional layer;
a first plurality of sample sites formed in the functional layer, wherein the first plurality of sample sites are arranged in a periodic pattern such that regions of the first plurality of sample sites are spaced apart at periodic intervals, wherein the first plurality of sample sites have a first value for a geometric parameter characterizing each sample site of the first plurality of sample sites; and
a second plurality of sample sites formed in the functional layer, wherein regions of the second plurality of sample sites are arranged in the periodic pattern alternating with regions of the first plurality of sample sites, wherein the second plurality of sample sites have a second value for the geometric parameter characterizing each sample site of the second plurality of sample sites.

2. The patterned flow cell of claim 1, further comprising a substrate layer adjacent to the functional layer.

3. The patterned flow cell of claim 1, wherein the first plurality of sample sites and the second plurality of sample sites each comprise nanowells and the geometric parameter comprises depth or diameter.

4. The patterned flow cell of claim 1, wherein the first plurality of sample sites have a third value for an additional geometric parameter characterizing each sample site of the first plurality of sample sites and the second plurality of sample sites have a fourth value for the additional geometric parameter characterizing each sample site of the second plurality of sample sites.

5. The patterned flow cell of claim 4, wherein the geometric parameter comprises depth and the additional geometric parameter comprises diameter.

6. The patterned flow cell of claim 5, wherein an aspect ratio for the sample sites is constant for both the first plurality of sample sites and the second plurality of sample sites.

7. The patterned flow cell of claim 1, wherein a reflectance for the first plurality of sample sites and the second plurality of sample sites differs due to a difference between the first value and the second value for the geometric parameter.

8. The patterned flow cell of claim 1, wherein the regions of the first plurality of sample sites are spaced apart at periodic intervals in a scanning direction associated with the flow cell.

9. The patterned flow cell of claim 1, wherein the periodic intervals are less than a diameter or width of one or more beams emitted by a focus sub-system configured to scan the patterned flow cell.

10. A patterned flow cell, comprising:
a substrate layer;
a functional layer proximate to the substrate layer;
a plurality of sample sites formed on a first surface of the functional layer; and
a plurality of features formed on one or more of: a second surface of the functional layer opposite the first surface, a surface of the substrate layer, or as a separate layer;
wherein the features of the plurality of features are spaced apart at periodic intervals in a scanning direction associated with the flow cell and wherein the plurality of features reflect or fluoresce in the presence of a wavelength different than that used by an imager sub-system used to scan the plurality of sample sites during a scan operation.

11. The patterned flow cell of claim 10, wherein the periodic intervals are less than a diameter or width of one or more beams emitted by a focus sub-system configured to scan the patterned flow cell.

12. The patterned flow cell of claim 10, wherein the patterned flow cell comprises a layer of deposited material and wherein the plurality of features are lithographically patterned features within the layer that have a different thickness than a remainder of the layer.

13. The patterned flow cell of claim 10, wherein the plurality of features have a different refractive index than one or both of the functional layer or the substrate layer with respect to the near infrared emissions.

14. The patterned flow cell of claim 10, wherein the plurality of features are formed from a layer of a material with a refractive index different than one or both of the functional layer or the substrate layer.

15. The patterned flow cell of claim 10, further comprising an additional plurality of features formed on one or more of: a second surface of the functional layer opposite the first surface; a surface of the substrate layer, or as a separate layer;
wherein the features of the additional plurality run continuously or intermittently in the scanning direction associated with the flow cell and are spaced apart in a cross-sample direction perpendicular to the scanning direction and wherein the plurality of additional features reflect or fluoresce in the presence of a near infrared energy emission.

16. The patterned flow cell of claim 15, wherein the plurality of features and the plurality of additional features are lithographically patterned within a layer of deposited material have a different thickness than a remainder of the layer.

17. The patterned flow cell of claim 10, wherein the plurality of features comprise a resin having a different refractive index than the substrate.

18. A sequencing instrument, comprising:
a sample stage configured to support a flow cell;
an imager sub-system comprising an objective lens, a photodetector, and a light source configured to operate in combination to image the flow cell when present on the sample stage;
a focusing sub-system comprising one or more focusing emitters and one or more focusing detectors, wherein the one or more focusing emitters operate at wavelengths different from wavelengths used by the imager sub-system; and
a controller configured to perform operations comprising:
linearly translating the sample stage holding the flow cell during a scanning operation;
using the imager sub-system, line scanning a plurality of sample sites formed in a top surface of the flow cell while the flow cell is linearly translated;
continuously or intermittently scanning the sample container with the one or more focusing emitters while the flow cell is linearly translated;
using the one or more focusing detectors, acquiring modulated intensity data over time in response to the one or more focusing emitters interacting with a plurality of periodically spaced apart features formed on the flow cell;
deriving at least a linear translation velocity of the flow cell based on the modulated intensity data; and
adjusting or calibrating one or both of a relative stage motion associated with linearly translating the flow cell or a signal integration performed on intensity data measured for the sample sites as part of line scanning the plurality of sample sites.

19. The sequencing instrument of claim 18, wherein the plurality of periodically spaced apart features formed on the flow cell comprise first and second regions of sample sites of the plurality of sample sites, wherein the first and second regions of sample sites vary periodically with respect to at least one geometric parameter in a scanning direction associated with linearly translating the flow cell.

20. The sequencing instrument of claim 19, wherein the at least one geometric parameter comprises at least one of depth or diameter of the sample sites.

21. The sequencing instrument of claim 19, wherein the first and second regions of sample sites vary periodically by a periodic interval less than a diameter or width of beams of the one or more focusing emitters.

22. The sequencing instrument of claim 19, wherein the plurality of periodically spaced apart features are formed on a bottom surface of a functional layer of the flow cell opposite the top surface and wherein the features of the plurality of periodically spaced apart features are spaced apart at a periodic interval in a scanning direction associated with linearly translating the flow cell.

23. The sequencing instrument of claim 22, wherein the features of the plurality of periodically spaced apart features reflect or fluoresce in the presence of the wavelengths emitted by the one or more focusing emitters.

24. The sequencing instrument of claim 22, wherein the periodic interval is less than a diameter or width of beams of the one or more focusing emitters.

25. The sequencing instrument of claim 22, wherein plurality of periodically spaced apart features are lithographically patterned features within a layer of deposited material, wherein the lithographically patterned features comprise thicker or thinner regions relative to the nominal area thickness of the layer.
